(19) United States
(12) Patent Application Publication
(10) Pub. No.: US 2023/0319900 A1
(43) Pub. Date: Oct. 5, 2023

(54) WAVEFORM SELECTION IN INITIAL ACCESS

(71) Applicant: QUALCOMM Incorporated, San Diego, CA (US)

(72) Inventors: Mohamad Sayed Hassan, Paris (FR); Jun Ma, San Diego, CA (US); Lianghai Ji, San Diego, CA (US); Liangping Ma, San Diego, CA (US); Huilin Xu, Temecula, CA (US); Karthik Anantha Swamy, La Jolla, CA (US); Mehmet Izzet Gurelli, San Diego, CA (US); Weimin Duan, San Diego, CA (US); Qiang Wu, San Diego, CA (US)

(21) Appl. No.: 17/712,681

(22) Filed: Apr. 4, 2022

(51) Int. Cl. H04W 74/08; H04W 72/02; H04W 72/04

(52) U.S. Cl. CPC H04W 74/0841; H04W 74/0866; H04W 72/02; H04W 72/0453

(57) ABSTRACT

Methods, systems, and devices for wireless communications are described. A user equipment (UE) may receive an indication of a waveform threshold for selecting a waveform type for transmitting a message of a random access procedure. The UE may select the waveform type for the message of the random access procedure based on the waveform threshold and a value associated with a power of signals received at the UE. The UE may transmit the message of the random access procedure to a network entity according to the waveform type selected for the message.

### FIELD OF TECHNOLOGY

The present disclosure relates to wireless communications, including waveform selection in initial access.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more network entities, each supporting wireless communication for communication devices, which may be known as user equipment (UE). In some examples of a wireless communications system, communication devices may support multiple waveform types for performing wireless communications.

### SUMMARY

The described techniques relate to improved methods, systems, devices, and apparatuses that support waveform selection in initial access. For example, the described techniques provide for selection of a waveform type in initial access based on radio conditions. A user equipment (UE) may receive an indication of a waveform threshold for selecting a waveform type for transmitting a message of a random access procedure. The UE may select the waveform type for the message of the random access procedure based on the waveform threshold and a value associated with a power of signals received at the UE. The UE may transmit the message of the random access procedure to a network entity according to the waveform type selected for the message.

A method for wireless communication at a UE is described. The method may include receiving an indication of a waveform threshold for selecting a waveform type for transmitting a message of a random access procedure, selecting the waveform type for the message of the random access procedure based on the waveform threshold and a value associated with a power of signals received at the UE, and transmitting the message of the random access procedure according to the waveform type selected for the message.

An apparatus for wireless communication at a UE is described. The apparatus may include a processor, memory coupled with the processor, and instructions stored in the memory. The instructions may be executable by the processor to cause the apparatus to receive an indication of a waveform threshold for selecting a waveform type for transmitting a message of a random access procedure, select the waveform type for the message of the random access procedure based on the waveform threshold and a value associated with a power of signals received at the UE, and transmit the message of the random access procedure according to the waveform type selected for the message.

Another apparatus for wireless communication at a UE is described. The apparatus may include means for receiving an indication of a waveform threshold for selecting a waveform type for transmitting a message of a random access procedure, means for selecting the waveform type for the message of the random access procedure based on the waveform threshold and a value associated with a power of signals received at the UE, and means for transmitting the message of the random access procedure according to the waveform type selected for the message.

A non-transitory computer-readable medium storing code for wireless communication at a UE is described. The code may include instructions executable by a processor to receive an indication of a waveform threshold for selecting a waveform type for transmitting a message of a random access procedure, select the waveform type for the message of the random access procedure based on the waveform threshold and a value associated with a power of signals received at the UE, and transmit the message of the random access procedure according to the waveform type selected for the message.

In some examples of the method, apparatuses, and non-transitory computer-readable medium described herein, the random access procedure includes a first type of random access procedure and the method, apparatuses, and non-transitory computer-readable medium may include further operations, features, means, or instructions for receiving an indication of a second waveform threshold for selecting a waveform type for UE transmissions of a second type of random access procedure.

In some examples of the method, apparatuses, and non-transitory computer-readable medium described herein, the waveform type selected for the message includes a first waveform type and the method, apparatuses, and non-transitory computer-readable medium may include further operations, features, means, or instructions for receiving an indication of a first set of resources for transmitting the message of the random access procedure according to the first waveform type and a second set of resources for transmitting the message of the random access procedure according to a second waveform type, where the message of the random access procedure may be transmitted using the first set of resources based on the first waveform type being selected for the message.

In some examples of the method, apparatuses, and non-transitory computer-readable medium described herein, the first set of resources include a first set of time-frequency resources and the second set of resources include a second set of time-frequency resources, the first set of resources include a first one or more preamble sequences and the second set of resources include second one or more preamble sequences, and any combination thereof.

Some examples of the method, apparatuses, and non-transitory computer-readable medium described herein may further include operations, features, means, or instructions for receiving an indication of a random access procedure threshold for selecting from a set of multiple random access procedures and selecting the random access procedure from the set of multiple random access procedures based on the random access procedure threshold and the value associated with the power for the signals received at the UE.

In some examples of the method, apparatuses, and non-transitory computer-readable medium described herein, the set of multiple random access procedures include at least a two-step random access procedure corresponding to the value associated with the power for the signals received at the UE satisfying the random access procedure threshold and a four-step random access procedure corresponding to the value associated with the power for the signals received at the UE failing to satisfy the random access procedure threshold.

In some examples of the method, apparatuses, and non-transitory computer-readable medium described herein, receiving the indication of the waveform threshold may include operations, features, means, or instructions for receiving a system information block (SIB) including the indication of the waveform threshold.

In some examples of the method, apparatuses, and non-transitory computer-readable medium described herein, the waveform type includes a first waveform type and the method, apparatuses, and non-transitory computer-readable medium may include further operations, features, means, or instructions for receiving an indication of a transmission quantity threshold for transmitting the message according to the first waveform type, where the transmission quantity threshold may be less than a maximum quantity of transmissions of the message during the random access procedure, and where the transmission quantity threshold corresponds to a quantity of random access attempts.

Some examples of the method, apparatuses, and non-transitory computer-readable medium described herein may further include operations, features, means, or instructions for transmitting a set of multiple messages according to the first waveform type, including the message and switching from transmitting the message according to the first waveform type to transmitting the message according to a second waveform type based on a quantity of the set of multiple messages exceeding the transmission quantity threshold.

In some examples of the method, apparatuses, and non-transitory computer-readable medium described herein, receiving the indication of the transmission quantity threshold may include operations, features, means, or instructions for receiving a SIB including the indication of the transmission quantity threshold.

Some examples of the method, apparatuses, and non-transitory computer-readable medium described herein may further include operations, features, means, or instructions for receiving one or more synchronization signals, where the signals received at the UE include the one or more synchronization signals, and the value associated with the power for the signals received at the UE may be based on the one or more synchronization signals.

In some examples of the method, apparatuses, and non-transitory computer-readable medium described herein, the power for the signals received at the UE includes a first power and the method, apparatuses, and non-transitory computer-readable medium may include further operations, features, means, or instructions for determining an offset between the first power and a second power for signals transmitted by the UE, where the waveform type of the message may be selected based on the offset.

In some examples of the method, apparatuses, and non-transitory computer-readable medium described herein, the offset may be associated with a difference between a first carrier frequency of the signals received at the UE and a second carrier frequency of the signals transmitted by the UE.

Some examples of the method, apparatuses, and non-transitory computer-readable medium described herein may further include operations, features, means, or instructions for determining the value associated with the power for the signals received at the UE based on a power class for the UE.

In some examples of the method, apparatuses, and non-transitory computer-readable medium described herein, the value associated with the power of the signals received at the UE include a reference signal received power (RSRP).

In some examples of the method, apparatuses, and non-transitory computer-readable medium described herein, selecting the waveform type may include operations, features, means, or instructions for selecting a first waveform type based on the value associated with the power for the signals received at the UE satisfying the waveform threshold and selecting a second waveform type based on the value associated with the power for the signals received at the UE failing to satisfy the waveform threshold, where the waveform type includes the first waveform type or the second waveform type.

In some examples of the method, apparatuses, and non-transitory computer-readable medium described herein, the second waveform type may be a waveform type that may be configured for a cell serving the UE.

In some examples of the method, apparatuses, and non-transitory computer-readable medium described herein, the waveform type includes a discrete Fourier transform spread orthogonal frequency division multiplexing (DFT-S-OFDM) waveform or a cyclic prefix orthogonal frequency division multiplexing (CP-OFDM) waveform.

A method for wireless communication at a network entity is described. The method may include outputting an indication of a waveform threshold for selecting a waveform type for a UE transmitting a message of a random access procedure and obtaining the message of the random access procedure, where the waveform type of the message is based on the waveform threshold.

An apparatus for wireless communication at a network entity is described. The apparatus may include a processor, memory coupled with the processor, and instructions stored in the memory. The instructions may be executable by the processor to cause the apparatus to output an indication of a waveform threshold for selecting a waveform type for a UE transmitting a message of a random access procedure and obtain the message of the random access procedure, where the waveform type of the message is based on the waveform threshold.

Another apparatus for wireless communication at a network entity is described. The apparatus may include means for outputting an indication of a waveform threshold for selecting a waveform type for a UE transmitting a message of a random access procedure and means for obtaining the message of the random access procedure, where the waveform type of the message is based on the waveform threshold.

A non-transitory computer-readable medium storing code for wireless communication at a network entity is described. The code may include instructions executable by a processor to output an indication of a waveform threshold for selecting a waveform type for a UE transmitting a message of a random access procedure and obtain the message of the random access procedure, where the waveform type of the message is based on the waveform threshold.

In some examples of the method, apparatuses, and non-transitory computer-readable medium described herein, the random access procedure includes a first type of random access procedure and the method, apparatuses, and non-transitory computer-readable medium may include further operations, features, means, or instructions for outputting an indication of a second waveform threshold for selecting a waveform type for UE transmissions of a second type of random access procedure.

In some examples of the method, apparatuses, and non-transitory computer-readable medium described herein, obtaining the message of the random access procedure may include operations, features, means, or instructions for attempting to decode the message of the random access procedure according to a set of multiple waveform types to determine the waveform type of the message.

In some examples of the method, apparatuses, and non-transitory computer-readable medium described herein, the waveform type includes a first waveform type, and obtaining the message of the random access procedure may include operations, features, means, or instructions for outputting an indication of a first set of resources for transmitting the message of the random access procedure according to the first waveform type and a second set of resources for transmitting the message of the random access procedure according to a second waveform type.

Some examples of the method, apparatuses, and non-transitory computer-readable medium described herein may further include operations, features, means, or instructions for outputting an indication of a random access procedure threshold for selecting from a set of multiple random access procedures.

In some examples of the method, apparatuses, and non-transitory computer-readable medium described herein, the set of multiple random access procedures include at least a two-step random access procedure corresponding to a value associated with a power for signals received at the UE satisfying the random access procedure threshold and a four-step random access procedure corresponding to the value associated with the power for the signals received at the UE failing to satisfy the random access procedure threshold.

In some examples of the method, apparatuses, and non-transitory computer-readable medium described herein, the waveform type includes a first waveform type and the method, apparatuses, and non-transitory computer-readable medium may include further operations, features, means, or instructions for outputting an indication of a transmission quantity threshold for transmitting the message according to the first waveform type, where the transmission quantity threshold may be less than a maximum quantity of transmissions of the message during the random access procedure.

Some examples of the method, apparatuses, and non-transitory computer-readable medium described herein may further include operations, features, means, or instructions for outputting a SIB including the indication of the waveform threshold.

### BRIEF DESCRIPTION OF THE DRAWINGS

FIGS. 1 and 2 each illustrate an example of a wireless communications system that supports waveform selection in initial access in accordance with one or more aspects of the present disclosure.

FIG. 3 illustrates an example of a process diagram that supports waveform selection in initial access in accordance with one or more aspects of the present disclosure.

FIGS. 4 and 5 each illustrate an example of a received power diagram that supports waveform selection in initial access in accordance with one or more aspects of the present disclosure.

FIG. 6 illustrates an example of a process flow that supports waveform selection in initial access in accordance with one or more aspects of the present disclosure.

FIGS. 7 and 8 show block diagrams of devices that support waveform selection in initial access in accordance with one or more aspects of the present disclosure.

FIG. 9 shows a block diagram of a communications manager that supports waveform selection in initial access in accordance with one or more aspects of the present disclosure.

FIG. 10 shows a diagram of a system including a device that supports waveform selection in initial access in accordance with one or more aspects of the present disclosure.

FIGS. 11 and 12 show block diagrams of devices that support waveform selection in initial access in accordance with one or more aspects of the present disclosure.

FIG. 13 shows a block diagram of a communications manager that supports waveform selection in initial access in accordance with one or more aspects of the present disclosure.

FIG. 14 shows a diagram of a system including a device that supports waveform selection in initial access in accordance with one or more aspects of the present disclosure.

FIGS. 15 through 18 show flowcharts illustrating methods that support waveform selection in initial access in accordance with one or more aspects of the present disclosure.

### DETAILED DESCRIPTION

A wireless communications system may include communication devices, such as a user equipment (UE) or one or more network entities. A network entity may be an example of a wired or wireless network node that may support one or multiple radio access technologies. Examples of radio access technologies may include fourth generation (4G) systems, such as LTE systems, and fifth generation (5G) systems, which may be referred to as 5G new radio (NR) systems, among other wireless communications systems (e.g., subsequent generations of wireless communications systems) or one or more other network entities.

In some wireless communications systems, user equipment (UE) may perform random access procedures, also referred to as random access channel (RACH) procedures to establish a connection with a network entity, such as a particular cell served by the network entity. In some examples, the UEs (e.g., and the network entity) may support multiple waveform types for wireless communications, such as a cyclic prefix orthogonal frequency division multiplexing (CP-OFDM) waveform or a direct Fourier transform spread orthogonal frequency division multiplexing (DFT-s-OFDM) waveform. In such examples, the network may configure the UEs to use one of the multiple waveform types for wireless communications with the network entity, such as for transmitting messages as part of a random access procedure. For example, the network may configure the UE to use a particular waveform based on the cell in which the UE may be operating. That is, the network may configure UEs operating on a cell to transmit random access messages using a cell-specific waveform type. In some examples, however, the cell-specific waveform may not be suitable for some UEs operating on the cell. For example, the CP-OFDM waveform may be suitable if a received power at a UE is relatively high (e.g., signal fading is relatively low, the channel conditions are relatively favorable), for example relative to the DFT-s-OFDM waveform. In some examples, the DFT-s-OFDM waveform may be suitable when the received power at the UE is relatively low (e.g., signal fading is relatively high, the channel conditions are relatively poor), for example relative to the CP-OFDM waveform.

Various aspects of the present disclosure relate to waveform selection in initial access, and more specifically, to waveform selection in initial access based on radio conditions of a communication device. For example, the present disclosure may provide for techniques for configuring the communication device, such as a UE, to select a waveform type for random access transmissions based on a received power measured at the UE. In some examples, the network may configure the UE with a waveform threshold to use to select between different waveform types. Additionally, or alternatively, the network may configure the UE with multiple (e.g., two, three, or more) waveform thresholds. In such an example, each waveform threshold may be associated with a respective random access procedure type. For example, the network may configure the UE with a waveform threshold for a relatively shorter random access procedure (e.g., a two-step random access procedure) having fewer steps and another waveform threshold for a relatively longer random access procedure (e.g., a four-step random access procedure) having a greater number of steps.

In some examples, as part of selecting a waveform type in initial access, the UE may measure the received power of reference signals transmitted by the network and determine whether a value of the measured received power (or a value of a metric based on the measured received power) satisfies a waveform type threshold configured by the network. In some examples, if the value of the measured received power fails to satisfy the waveform threshold (e.g., fails to exceed the waveform threshold) the UE may use one waveform type configuration supported by the UE, such as the DFT-s-OFDM waveform. Additionally, or alternatively, if the value of the measured received power satisfies the waveform threshold, the UE may use another waveform type configuration supported by the UE, such as a cell-specific waveform as configured by the network. The cell-specific waveform may correspond to the CP-OFDM waveform or the DFT-s-OFDM waveform, among other examples.

In some examples, the network may configure the UE to switch waveform types during an initial access procedure. For example, the UE may determine to use a waveform type, such as the CP-OFDM waveform, for transmitting a message as part of a random access procedure. In such an example, if the UE fails to receive a random access response from the network after transmitting a quantity of random access messages during the random access procedure (e.g., after a threshold quantity of attempts), the UE may switch form the first waveform type to another waveform type, such as the DFT-s-OFDM waveform. In such an example, the threshold quantity of attempts may be configured for the UE by the network.

Particular aspects of the subject matter described herein may be implemented to realize one or more of the following potential advantages. For example, the techniques employed by the described communication devices may provide benefits and enhancements to wireless communication devices operating within the network, including enabling increased reliability of wireless communications within the wireless communications system. In some examples, operations performed by the described communication devices may provide improvements to techniques for random access procedures performed within the wireless communications system for gaining access to a wireless communications network, such as a cell supported by a network entity. The operations performed by the described communication devices to improve techniques for random access procedures may enabling a communication device to select a waveform type in initial access based on radio conditions experienced by the communication device. In some other implementations, operations performed by the described wireless communication devices may also support improvements to user experience and higher data rates, among other benefits.

Aspects of the disclosure are initially described in the context of wireless communications systems. Aspects of the disclosure are also described in the context of a process diagram, received power diagrams, and a process flow. Aspects of the disclosure are further illustrated by and described with reference to apparatus diagrams, system diagrams, and flowcharts that relate to waveform selection in initial access.

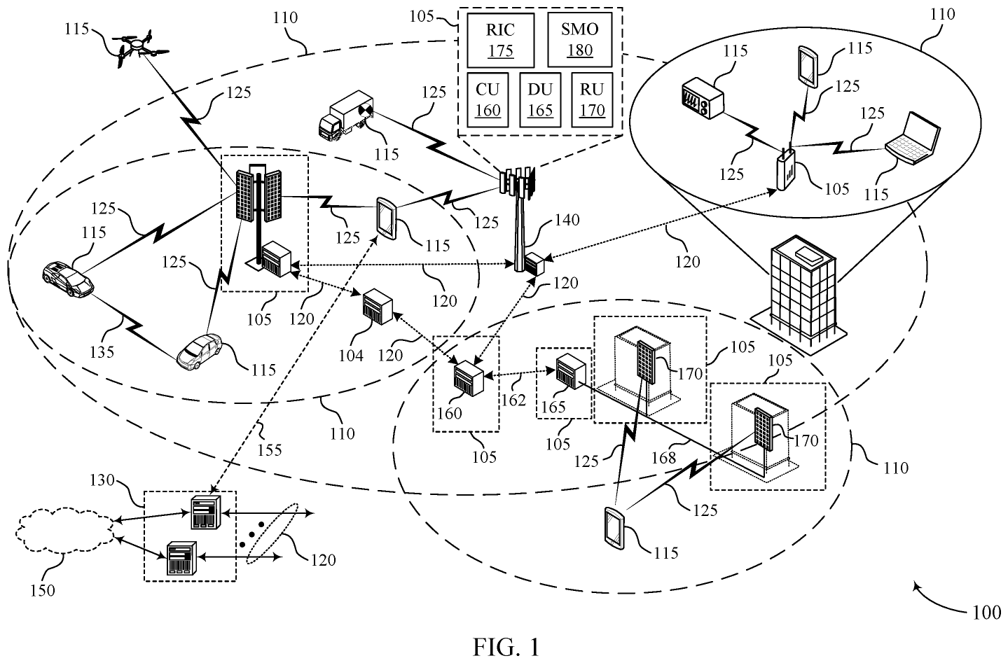

FIG. 1 illustrates an example of a wireless communications system 100 that supports waveform selection in initial access in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support waveform selection in initial access as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

Devices in wireless communications system 100 may communicate over unlicensed spectrum, such as the 5 GHz band, the 2.4 GHz band, the 60 GHz band, the 3.6 GHz band, and/or the 900 MHz band. The unlicensed spectrum may also include other frequency bands.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support waveform selection in initial access. For example, a UE 115 may receive an indication of a waveform threshold for selecting a waveform type for transmitting a message of a random access procedure. The UE 115 may select the waveform type for the message of the random access procedure based on the waveform threshold and a value associated with a power of signals received at the UE 115. The UE 115 may transmit the message of the random access procedure to a network entity 105 according to the waveform type selected for the message. In some examples, by selecting a waveform type in initial access based on radio conditions experienced by the UE 115 (e.g., the value associated with the power of the received signals), the UE 115 may increase the reliability of wireless communications between the UE 115 and the network entity 105, among other benefits.

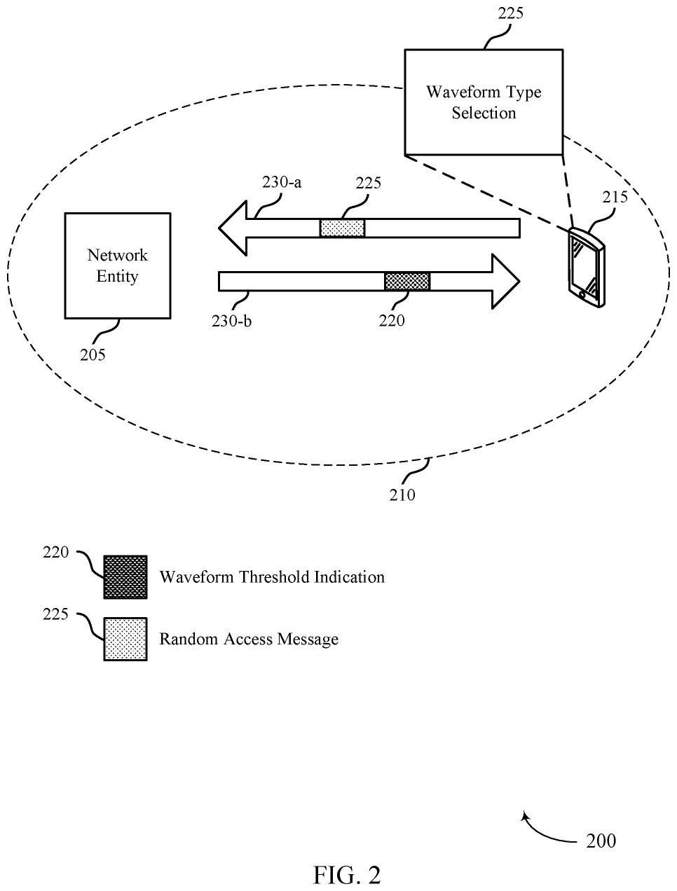

FIG. 2 illustrates an example of a wireless communications system 200 that supports waveform selection in initial access in accordance with one or more aspects of the present disclosure. In some examples, the wireless communications system 200 may implement or be implemented by one or more aspects of the wireless communications system 100. For example, the wireless communications system 200 may include a UE 215 and a network entity 205, which may be examples of the corresponding devices as described with reference to FIG. 1. In the example of FIG. 2, the network entity 205 may be an example of a CU, a DU, an RU, a base station, an IAB node, a transmission and reception point, or one or more other network nodes as described with reference to FIG. 1.

The network entity 205 and the UE 215 may communicate within the coverage area 210, which may be examples of a coverage area 110 as described with reference to FIG. 1. For example, the UE 215 and the network entities 205 may communicate via one or more communication links 230. In some examples, the UE 215 may transmit communications (e.g., uplink communications) to the network entity 205 via a communication link 230-a and the network entity 205 may transmit communications (e.g., downlink communications) to the UE 215 via a communication link 230-b. In the example of FIG. 2, the communication link 230-a may be an uplink and the communication link 230-b may be a downlink. Additionally, or alternatively, the communication links 230 may each be an example of a communication link 125 as described with reference to FIG. 1. The wireless communications system 200 may include features for improved communications between the UE 215 and the network entity 205, among other benefits.

The wireless communications system 200 may support one or more random access procedures for gaining access to a wireless communications network. For example, the UE may perform a random access procedure (e.g., a RACH procedure) to establish a connection with the network entity 205, such as a particular cell served by the network entity 205. In some examples, the UE 215 may support multiple waveform types for transmitting random access messages as part of the random access procedure. For example, the UE 215 may support a CP-OFDM waveform or a DFT-s-OFDM waveform. In some examples, the DFT-s-OFDM waveform may correspond to transform precoding being enabled at the UE 215 and the CP-OFDM waveform may correspond to transform precoding being disabled at the UE 215.

In some examples, by using the CP-OFDM waveform, the UE 215 may achieve increased spectral packing efficiency. Additionally, or alternatively, the CP-OFDM waveform may enable the network (e.g., network entity 205, a base station 140) to better manage resource block allocation. In some examples, by using the DFT-s-OFDM waveform, the UE 215 may achieve a reduced peak to average power ratio (PAPR) and, as such, may transmit signals at an increased power (e.g., relative to signals transmitted via the CP-OFDM waveform), thereby achieving increased signal coverage. Accordingly, the CP-OFDM waveform may be suitable for scenarios in which the received power at the UE 215 may be relatively high (e.g., signal fading may be relatively low, channel conditions relatively favorable, channel conditions satisfy a threshold) and the DFT-s-OFDM waveform may be suitable for scenarios in which the received power at the UE 215 may be relatively low (e.g., signal fading may be relatively high, the channel conditions may be reduced). That is, the DFT-s-OFDM waveform may provide one or more benefits for uplink coverage due to a reduced PAPR relative to the CP-OFDM waveform.

In some examples, however, the network may configure the UE 215 to use a waveform type irrespective of the radio conditions (e.g., channel conditions) experienced by the UE 215. For example, the network may configure the UE 215 to use a waveform type based on the cell in which the UE 215 may be operating (e.g., the configured waveform type may be cell-specific). In some examples, a waveform type (e.g., a waveform type to be used for uplink transmissions, an uplink waveform type) may be configured via a random access configuration (e.g., a RACH common configuration), which may be used by the network to specify cell-specific random access parameters. For example, the waveform type to be used by UE 215 for transmitting a random access message (e.g., a first message transmission of a two-step RACH procedure or a third message transmission of a four-step RACH procedure) may be based on a higher layer parameter or the random access configuration (e.g., the RACH configuration transmitted via a system information broadcast message), such as may be indicated to the UE 215 via a msg3-TransformPrecoder information element (IE) or a msgA-TransformPrecoder IE. In such an example, the UE 215 may consider the transform precoding either enabled (e.g., indicating for the UE 215 to use the DFT-s-OFDM waveform) or disabled (e.g., indicating for the UE 215 to use the CP-OFDM waveform) based on the higher layer parameter or the random access configuration (e.g., the RACH configuration transmitted via the system information broadcast message). It is to be understood that the names of IEs described herein may change based on implementation of one or multiple devices (e.g., the UE 215, the network entity 205, or both), and the examples described herein should not be considered limiting to the scope covered by the claims or the disclosure.

In some examples, such as for a normal PUSCH transmission (e.g., after initial access), the UE 215 may apply a fast switching of the waveform for the PUSCH transmission based on a threshold configured by the network and the received power measured at the UE 215 (e.g., and reported to the network). In some examples, the network may schedule such uplink transmissions for the 215 via a DCI (e.g., DCI format 0_0, or other DCI with CRC scrambled using a radio access temporary network identifier (RNTI), such as a temporary cell RNTI (TC-RNTI)).

In some examples, the higher layer parameter or the random access configuration (e.g., the RACH configuration transmitted via a system information broadcast message) used to configure the UE 215 with a waveform type for transmitting a message as part of a random access procedure (e.g., a contention based random access procedure or a contention free random access procedure) may be cell-specific and may not be selected based on the radio conditions of the UE 215 (e.g., UE radio conditions). Moreover, switching from the CP-OFDM waveform to the DFT-s-OFDM waveform may be prohibitive for the UE 215, for example if the UE 215 is operating at or near an edge of the cell. Additionally, or alternatively, a quantity of UEs 215 connected to a same SSB beam (e.g., a quantity of UEs spatially located such that each UE may receive an SSB transmitted from the network in a same beamforming direction) may be relatively high and each of the UEs 215 may experience different radio conditions. In such an example, a distribution of the received signal strength of SSBs (e.g., a synchronization signal reference signal received power (SS-RSRP)) among the UEs 215 connected to a same SSB beam may be spread over a relatively wide range.

In some examples, techniques for waveform selection in initial access, as described herein, may provide one or more enhancements to wireless communications between the UE 215 and the network. For example, techniques employed by the UE 215 and the network entity 205 may enable group-specific waveform selection in initial access based on UE radio conditions. As illustrated in the example of FIG. 2, the network entity 205 may transmit a group-specific indication of a waveform configuration (e.g., a group-specific waveform configuration) to the UE 215 during an initial access procedure, such as a two-step RACH procedure or a four-step RACH procedure (e.g., one or more contention based random access procedures, one or more contention free random access procedures). In some examples, the waveform configuring may be based on radio conditions of the UE 215 (i.e., channel conditions experienced by the UE 215). Additionally, or alternatively, the waveform configuring may enable switching between the DFT-S-OFDM waveform and the CP-OFDM waveform.

In some examples, the network may configure the UE 215 to determine (e.g., select) a waveform type based on received power (e.g., a reference signal received power (RSRP)) of signals transmitted by the network entity 205. For example, the UE 215 may determine the waveform type based on whether a value associated with the received power (e.g., an SS-RSRP or an effective RSRP) of a signal transmitted by the network entity 205. In some examples, if the received power of the signal fails to satisfy a waveform threshold (e.g., fails to exceed a waveform threshold), the UE 215 may determine to use the DFT-S-OFDM waveform. Additionally, or alternatively, if the received power of the signal satisfies the waveform threshold (e.g., exceeds the waveform threshold), the UE 215 may determine to use a cell-specific waveform. In some examples, the cell-specific waveform may include the DFT-S-OFDM waveform or the CP-OFDM waveform.

In some examples, the network may configure the UE 215 with multiple waveform thresholds. For example, the network may configure the UE 215 with a waveform threshold for a four-step random access procedure (e.g., via a msg3-waveform-RSRP-Threshold IE or another waveform-RSRP-Threshold IE for a four-step random access procedure) and a waveform threshold for a two-step random access procedure (e.g., via a msgA-waveform-RSRP-Threshold IE or another waveform-RSRP-Threshold IE for a two-step random access procedure). In such an example, if the UE 215 performs a four-step random access procedure, the UE 215 may select a waveform based on the waveform threshold indicated via the msg3-waveform-RSRP-Threshold IE (or another waveform-RSRP-Threshold IE for a four-step random access procedure). Additionally, or alternatively, if the UE 215 performs a two-step random access procedure, the UE 215 may select a waveform based on the waveform threshold indicated via the msgA-waveform-RSRP-Threshold IE (or another waveform-RSRP-Threshold IE for a two-step random access procedure).

In some examples, if the UE 215 determines to perform (e.g., selects) a two-step random access procedure, a first random access message (e.g., MsgA) transmitted by the UE 215 (e.g., using the selected waveform type) may include a random access preamble (e.g., a preamble sequence, a Zadoff-Chu sequence). In such an example, the network may configure the UE 215 with a parameter that may indicate a threshold quantity (N) of random access preamble transmissions (e.g., a threshold quantity of random access attempts) that the UE 215 may perform prior to switching to another waveform type (e.g., a transmission quantity threshold). For example, the network may configure the UE 215 to perform a quantity (e.g., a maximum quantity or an otherwise suitable quantity) of random access preamble transmission prior to determining (e.g., declaring) a random access procedure failure. That is, if the UE 215 transmits a quantity of random access messages (e.g., that exceeds the threshold quantity of random access attempts) using a first waveform type (e.g., the CP-OFDM waveform) and fails to receive a random access response from the network entity 205, the UE 215 may determine that the random access procedure failed.

In such an example (e.g., if the random access procedure fails after the UE 215 performs the threshold quantity of random access attempts), the UE 215 may switch from the first waveform type to a second waveform type (e.g., the DFT-S-OFDM waveform). For example, to enhance random access preamble transmissions, the network may configure the UE 215 to perform dynamic waveform switching (e.g., subsequent to the UE 215 performing the threshold quantity of random access attempts). In some examples, the threshold quantity of random access attempts may not exceed a quantity of random access transmissions (e.g., preamble transmissions) that the UE 215 may be capable of performing over (e.g., during) the random access procedure (e.g., a maximum quantity of random access preamble transmissions, such as indicated via a preambleTransMax IE).

In some examples, the network entity 205 may determine (e.g., detect) the waveform type selected by the UE 215 using blind detection. For example, the network entity 205 may blindly decode (e.g., perform waveform blind detection) random access messages transmitted by the UE 215 using the selected waveform type. Additionally, or alternatively, the network may configure the UE 215 with one or more resources (e.g., random access resources, time-frequency resources), one or more occasions (e.g., random access occasions), or one or more sequences (e.g., random access sequences) for transmitting the random access message using the DFT-s-OFDM and one or more other resources, one or more other occasions, or one or more other sequences for transmitting the random access message using the CP-OFDM waveform. As such, the network entity 205 may determine the waveform selected by the UE 215 based on the resource, occasion, or sequence in which the random access message was transmitted. In some examples, if a waveform threshold (e.g., indicated via the msg3-waveform-RSRP-Threshold IE or the msgA-waveform-RSRP-Threshold IE) is not configured for the UE 215, the UE 215 may transmit the random access message according the cell-specific waveform. As such, the network may flexibility determine whether to configure the UE 215 to select a waveform type based on the received power of signals transmitted by the network. In some examples, the network may determine whether to configure the UE 215 to select a waveform based on the received (e.g., the SS-RSRP range) observed (or reported) by the UEs in which the network entity 205 is serving (e.g., the UE 215 and one or more other UEs).

As illustrated in the example of FIG. 2, the UE 215 may receive a waveform threshold indication 220 from the network entity 205. In some examples, the waveform threshold indication 220 may indicate a waveform threshold for selecting a waveform type for transmitting a message of a random access procedure (e.g., a random access message 225). The UE 215 may select the waveform type for the random access message 225 based on the waveform threshold and a value associated with a power of signals received at the UE 215 (e.g., from the network entity 205). The UE 215 may transmit the random access message 225 according to the waveform type selected for the random access message 225.

In some examples, by configuring the UE to select a waveform at initial access based on radio conditions of the UEs (e.g., the UE 215 and one or more other UEs), the network may enable flexible configuration of the UE 215 and provide one or more enhancements to the performance of random access messages (e.g., a first message in a two-step random access procedure or a third message in a four-step random access procedure) transmitted by the UE 215. For example, by enabling dedicated waveform selection for the UE 215 at initial access, the network may reduce signaling overhead associated with re-configuring (or configuring) the UE 215 with a waveform type, such as for subsequent uplink transmissions. That is, by configuring the UE 215 with a waveform based on the radio conditions of the UE 215 at initial access (e.g., based on SS-RSRP, effective RSRP, or another received power metric determined at the UE 215 during initial access), the network may enable flexible configuration of a waveform type for the UE 215 as well as one or more enhancements to random access procedures, among other benefits.

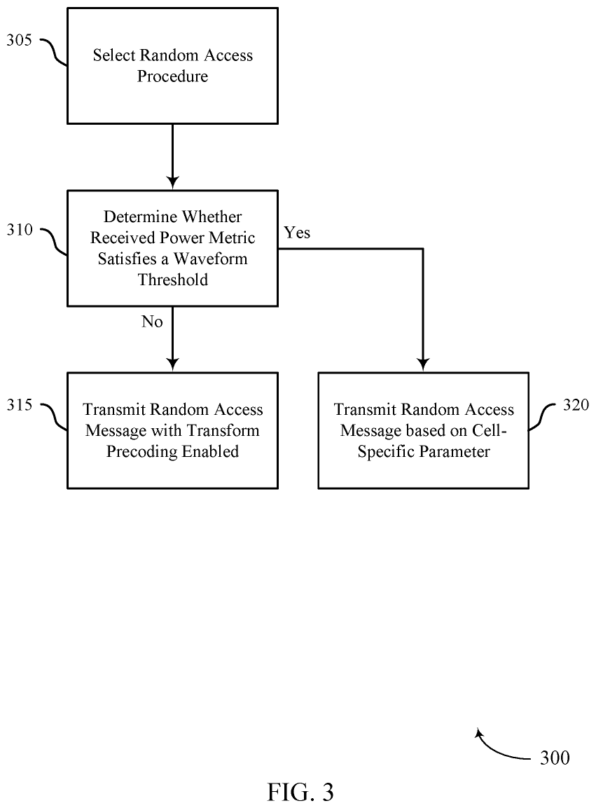

FIG. 3 illustrates an example of a process diagram 300 that supports waveform selection in initial access in accordance with one or more aspects of the present disclosure. In some examples, the process diagram 300 may implement or be implemented by one or more aspects of the wireless communications system 100 and the wireless communications system 200. For example, the process diagram 300 may be implemented by a UE and a network entity, which may be examples of the corresponding devices as described with reference to FIG. 1. In the example of FIG. 3, the network entity may be an example of a CU 160, a DU 165, or an RU 170, a base station 140, an IAB node 104, a transmission and reception point, or one or more other network nodes as described with reference to FIG. 1. The process diagram 300 may include features for improved communications between the UE and the network, among other benefits.

As illustrated in the example of FIG. 3, a communication device (e.g., a UE) may support multiple random access procedures (e.g., a two-step random access procedure and a four-step random access procedure) for establishing a connection with a wireless communications network (e.g., a cell served by one or more network entities). As such, at 305, the UE may select a random access procedure. In some examples, the UE may select a random access procedure according to (e.g., based on) a bandwidth part selected for the random access procedure. For example, a bandwidth part selected for performing the random access procedure (e.g., a contention based random access procedure) may be configured with a particular type of random access procedure (e.g., a two-step random access procedure). That is, resources (e.g., contention based random access resources indicated via a rach-ConfigDedicated IE) in a bandwidth part selected for communications with the network (e.g., an uplink bandwidth indicated via a firstActiveUplinkBWP-ID IE) may be configured for a particular random access procedure (e.g., a two-step random access procedure). In such an example, the UE may perform the random access procedure configured for the selected bandwidth part.

In some other examples, the UE may be configured to select a random access procedure based on whether a value of a received power metric (e.g., determined at the UE) satisfies a random access procedure threshold. In some examples, the received power metric may be an example of a received power metric as described with reference to FIG. 2. For example, the received power metric may correspond to one or more SS-RSRP measurements performed at the UE (e.g., on SSBs transmitted by the network) or an effective RSRP measurement. In some examples, the effective RSRP measurement may calculated by the UE based on the one or more SS-RSRP measurements performed at the UE, an RSRP difference (e.g., a delta RSRP) between uplink signals transmitted by the UE and the signals (e.g., downlink reference signals) transmitted by the network (e.g., if the UE is configured to perform FDD operations and the uplink carrier frequency is different form the downlink carrier frequency), a UE power class, or any combination thereof. In some examples, the network may configure the UE with the random access procedure threshold via a parameter, such as a msgA-RSRP-Threshold IE. In some examples, if the received signal strength satisfies the random access procedure threshold (e.g., exceeds the threshold), the UE may determine to perform (e.g., may select) a two-step random access procedure. Additionally, or alternatively, if the received power metric fails to satisfy the threshold (e.g., fails to exceed the threshold), the UE may determine to perform a four-step random access procedure.

Additionally, or alternatively, the UE may support multiple waveform types for transmitting random access messages as part of the random access procedure (e.g., selected at 305). For example, the UE may support a CP-OFDM waveform and a DFT-s-OFDM waveform. In some examples, the CP-OFDM waveform and a DFT-s-OFDM waveform may be examples of the corresponding waveforms as described with reference to FIG. 2. For example, the DFT-s-OFDM waveform may correspond to transform precoding being enabled at the UE and the CP-OFDM waveform may correspond to transform precoding being disabled at the UE.

In some examples, the UE may determine (e.g., select) a waveform type based on whether the received power metric determined at the UE satisfies a waveform threshold. For example, at 310, the UE may determine whether the received power metric satisfies the waveform threshold. In some examples, the network may configure the UE with multiple waveform thresholds. For example, the network may configure the UE with a waveform threshold for the four-step random access procedure (e.g., via a msg3-waveform-RSRP-Threshold IE or another waveform-RSRP-Threshold IE for a four-step random access procedure configured through the RACH-ConfigCommon IE). That is, the network may indicate (e.g., via the RACH-ConfigCommon IE) a configuration for a four-step random access procedure that may include a parameter indicating a waveform threshold for the four-step random access procedure (e.g., the msg3-waveform-RSRP-Threshold IE), a parameter indicating a received power threshold for selecting an SSB (e.g., an rsrp-ThresholdSSB IE), and a parameter indicating another received power threshold for selecting between a normal uplink carrier and a supplemental uplink carrier (e.g., a rsrp-ThresholdSSB-SUL IE), among other examples. In some examples, if the UE determines to perform the four-step random access procedure (e.g., at 305), the UE may select a waveform based on the waveform threshold indicated via the msg3-waveform-RSRP-Threshold IE (or another waveform-RSRP-Threshold IE for a four-step random access procedure).

Additionally, or alternatively, the network may configure the UE with a waveform threshold for the two-step random access procedure (e.g., via a msgA-waveform-RSRP-Threshold IE or another waveform-RSRP-Threshold IE for a two-step random access procedure included in the RACH-ConfigCommonTwoStepRA IE). That is, the network may indicate (e.g., via the RACH-ConfigCommonTwoStepRA IE) a configuration for a two-step random access procedure that may include a parameter indicating a waveform threshold for the two-step random access procedure (e.g., the msgA-waveform-RSRP-Threshold IE), a parameter indicating a quantity of random access message transmissions (e.g., a maximum quantity of transmissions or an otherwise suitable quantity of transmissions) to be performed by the UE during the random access procedure (e.g., an msgA-TransMax IE), and a parameter indicating another received power threshold for selecting between the two-step random access procedure and a four-step random access procedure (e.g., a msgA-RSRP-Threshold IE), among other examples. Therefore, if the UE determines to perform the two-step random access procedure (e.g., at 305), the UE may select a waveform based on the waveform threshold indicated via the msgA-waveform-RSRP-Threshold IE (or another waveform-RSRP-Threshold IE for a two-step random access procedure).

For example, if at 310 the UE determines that the received power metric fails to satisfy (e.g., fails to exceed) the waveform threshold (e.g., as indicated by the msgA-waveform-RSRP-Threshold IE or as indicated by the msg3-waveform-RSRP-Threshold IE), the UE may determine to use the DFT-S-OFDM waveform. That is, at 315, the UE may transmit a random access message (e.g., a first message of the two-step random access procedure or the third message of the four-step random access procedure) with transform precoding enabled at the UE. Additionally, or alternatively, if at 310 the UE determines that the received power metric satisfies the waveform threshold (e.g., exceeds the waveform threshold), the UE may determine to use a cell-specific waveform. That is, at 320, the UE may transmit the random access message (e.g., a first message of the two-step random access procedure or the third message of the four-step random access procedure) based on a cell-specific parameter indicated to the UE by the network. In some examples, if the UE determines to perform a two-step random access procedure (e.g., at 305), the cell-specific parameter may be indicated to the UE via the msgA-TransformPrecoder field of the MsgA-PUSCH-config IE.

Additionally, or alternatively, if the UE determines to perform a four-step random access procedure (e.g., at 305), the cell-specific parameter may be indicated to the UE via the msg3-TransformPrecoder field of the RACH-ConfigCommon IE. In some examples, if the cell-specific parameter indicates for transform precoding to be enabled, the UE may transmit the random access message (e.g., at 320) using the DFT-S-OFDM waveform. Additionally, or alternatively, if the cell-specific parameter indicates for transform precoding to be disabled, the UE may transmit the random access message (e.g., at 320) using the CP-OFDM waveform. In some examples, by configuring the UE to select a waveform at initial access based on whether the received power metric determined at the UE satisfies a waveform threshold (i.e., based on the radio conditions of the UE), the network may provide one or more enhancements to random access procedures performed by the UE, among other benefits.

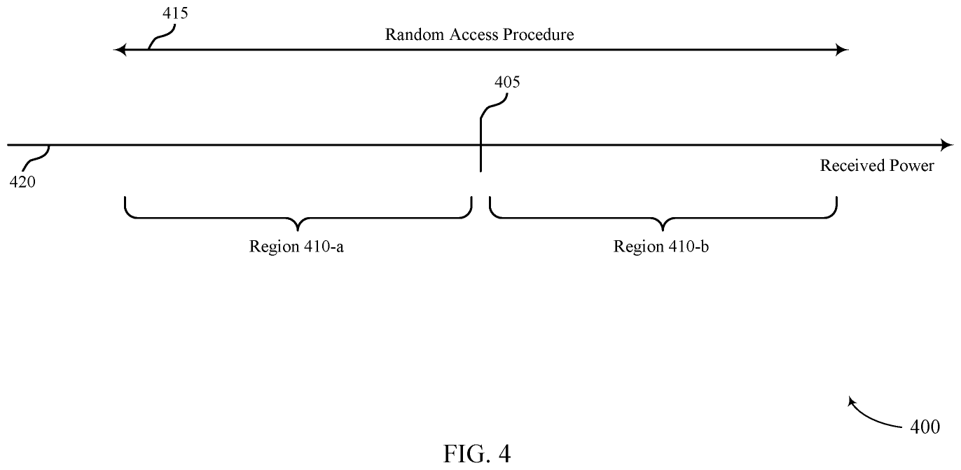

FIG. 4 illustrates an example of a received power diagram 400 that supports waveform selection in initial access in accordance with one or more aspects of the present disclosure. In some examples, the received power diagram 400 may implement or be implemented by one or more aspects of the wireless communications system 100 and the wireless communications system 200. For example, the received power diagram 400 may be implemented by a UE and a network entity, which may be examples of the corresponding devices as described with reference to FIG. 1. In the example of FIG. 4, the network entity may be an example of a CU 160, a DU 165, or an RU 170, a base station 140, an IAB node 104, a transmission and reception point, or one or more other network nodes as described with reference to FIG. 1. The received power diagram 400 may include features for improved communications between the UE and the network, among other benefits.

A wireless communications device (e.g., the UE) may support multiple waveform types for wireless communications with the network. For example, the UE may support a CP-OFDM waveform in which transform precoding may be disable at the UE and a DFT-s-OFDM waveform in which transform precoding may be enabled at the UE. In some examples, the UE may be configured to select a waveform type (e.g., of the multiple waveform types supported by the UE) at initial access based on radio conditions experienced by the UE. For example, the UE may determine to perform a random access procedure 415. In some examples, the random access procedure 415 may be an example of a two-step random access procedure or a four step random access procedure.

As part of the random access procedure 415, the UE may transmit one or more random access messages. In some examples, the UE may determine a waveform type for transmitting a random access message based on whether a value of a received power 420 determined at the UE exceeds or fails to exceed a waveform threshold 405. In some examples, the waveform threshold 405 may be a first waveform threshold associated with a two-step random access procedure (e.g., a waveform threshold indicated to the UE via a msgA-waveform-RSRP-Threshold IE) or a second waveform threshold associated with a four-step random access procedure (e.g., a waveform threshold indicated to the UE via a msg3-waveform-RSRP-Threshold IE).

As illustrated in the example of FIG. 4, if the value of the received power 420 fails to exceed the waveform threshold 405 (e.g., if the value of the received power 420 occurs in a region 410-a) the UE may determine to transmit the random access message (e.g., a first message of a two-step random access procedure or a third message of a four-step random access procedure) with transform precoding enabled (e.g., using the DFT-S-OFDM waveform). Additionally, or alternatively, if the value of the received power 420 exceeds the waveform threshold 405 (e.g., if the value of the received power 420 occurs in a region 410-b) the UE may determine to transmit the random access message (e.g., a first message of a two-step random access procedure or a third message of a four-step random access procedure) with transform precoding enabled (e.g., using the DFT-S-OFDM waveform) or with transform precoding disabled (e.g., using the CP-OFDM waveform) based on a cell-specific parameter (e.g., the msgA-TransformPrecoder IE of the MsgA-PUSCH-config IE or the msg3-TransformPrecoder IE of the RACH-ConfigCommon IE). That is, if the value of the received power 420 occurs in the region 410-b, the UE may transmit the random access message using a cell-specific waveform type indicated via the cell-specific parameter.

In some examples, by configuring the UE with one or more waveform thresholds for selecting a waveform type at initial access based on the radio conditions of the UE, the network may provide one or more enhancements to random access procedures performed by the UE, among other benefits.

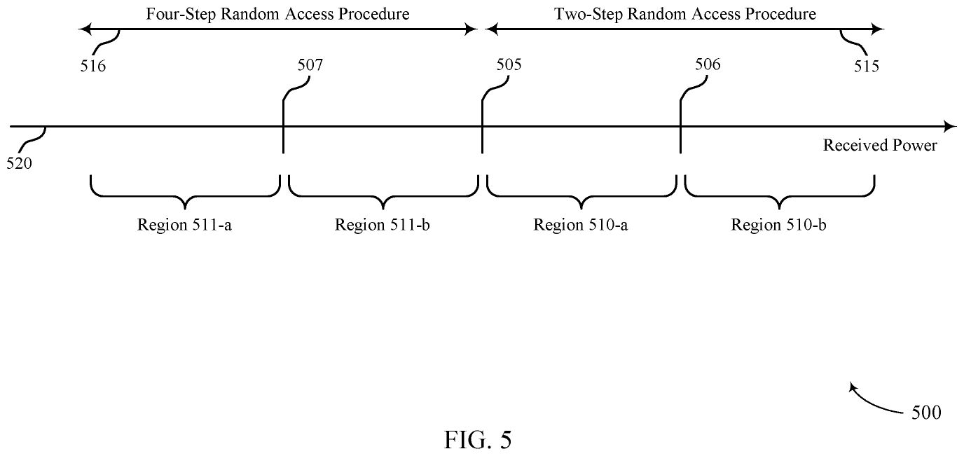

FIG. 5 illustrates an example of a received power diagram 500 that supports waveform selection in initial access in accordance with one or more aspects of the present disclosure. In some examples, the received power diagram 500 may implement or be implemented by one or more aspects of the wireless communications system 100 and the wireless communications system 200. For example, the received power diagram 500 may be implemented by a UE and a network entity, which may be examples of the corresponding devices as described with reference to FIG. 1. In the example of FIG. 5, the network entity may be an example of a CU 160, a DU 165, or an RU 170, a base station 140, an IAB node 104, a transmission and reception point, or one or more other network nodes as described with reference to FIG. 1. The received power diagram 500 may include features for improved communications between the UE and the network, among other benefits.

A wireless communications device (e.g., the UE) may support multiple waveform types for wireless communications with the network. For example, the UE may support a CP-OFDM waveform in which transform precoding may be disable at the UE and a DFT-s-OFDM waveform in which transform precoding may be enabled at the UE. In some examples, the UE may be configured to select a waveform type (e.g., of the multiple waveform types supported by the UE) at initial access based on radio conditions experienced by the UE.

For example, the UE may perform a random access procedure to establish a connection with a wireless communications network (e.g., a cell supported by the network entity). In some examples, the UE may determine to perform a two-step random access procedure 515 or a four-step random access procedure 516 based on whether a value of a received power 520 determined at the UE exceeds or fails to exceed a random access procedure threshold 505. In some examples, the received power may correspond to one or more SS-RSRP measurements performed at the UE (e.g., on SSBs transmitted by the network) or an effective RSRP measurement. In some examples, the effective RSRP measurement may calculate by the UE based on the one or more SS-RSRP measurements performed at the UE, an RSRP difference (e.g., a delta RSRP) between uplink signals transmitted by the UE and the signals (e.g., downlink reference signals) transmitted by the network (e.g., if the UE is configured to perform FDD operations and the uplink carrier frequency is different form the downlink carrier frequency), a UE power class, or any combination thereof. In some examples, the network may configure the UE with the random access procedure threshold 505 via a parameter, such as a msgA-RSRP-Threshold IE.

In some examples, if the value of the received power 520 exceeds the random access procedure threshold 505 (e.g., the value of the received power 520 occurs within a region 511-a or a region 511-b), the UE may determine to perform the two-step random access procedure 515. Additionally, or alternatively, if the value of the received power 520 fails to exceed the random access procedure threshold 505 (e.g., the value of the received power 520 occurs within a region 510-a or a region 510-b), the UE may determine to perform the four-step random access procedure 516.

As part of the two-step random access procedure 515, the UE may transmit one or more random access messages. In some examples, the UE may determine a waveform type for transmitting a first random access message (e.g., MsgA) based on whether the value of a received power 520 exceeds or fails to exceed a first waveform threshold 506 (e.g., indicated to the UE via a msgA-waveform-RSRP-Threshold IE). For example, if the value of the received power 520 fails to exceed the first waveform threshold 506 (e.g., if the value of the received power 520 occurs in a region 510-a) the UE may determine to transmit the first random access message with transform precoding enabled (e.g., using the DFT-S-OFDM waveform). Additionally, or alternatively, if the value of the received power 520 exceeds the first waveform threshold 506 (e.g., if the value of the received power 520 occurs in a region 510-b) the UE may determine to transmit the first random access message with transform precoding enabled (e.g., using the DFT-S-OFDM waveform) or with transform precoding disabled (e.g., using the CP-OFDM waveform) based on a cell-specific parameter (e.g., the msgA-TransformPrecoder IE of the MsgA-PUSCH-config IE). That is, if the value of the received power 520 occurs in the region 510-b, the UE may transmit the random access message using a cell-specific waveform type indicated via the cell-specific parameter configured for the two-step random access procedure 515.

In some examples, the network may configure the UE to switch the waveform type during the two-step random access procedure 515. For example, the network may configure the UE to switch from the CP-OFDM waveform (e.g., a waveform type corresponding to transform precoding disabled at the UE) to a DFT-s-OFDM waveform (e.g., a waveform type corresponding to transform precoding enabled) after a threshold quantity (N) of random access message transmissions (e.g., after N attempts), to reduce the PAPR. In some examples, the threshold quantity (N) may be less than a quantity of random access messages the UE may be capable of transmitted (e.g., a quantity indicated via a preambleTransMax IE). That is, the value of threshold quantity of attempts (N) may be relatively less than the value of a parameter, such as indicated via the preambleTransMax IE. In some examples, the network may configure the UE to switch waveform types via an IE in a system information block (SIB) that indicates the threshold quantity of attempts (N) that the UE may perform prior to switching from the CP-OFDM waveform to the DFT-s-OFDM waveform. In some examples, the parameter (e.g., IE) used by the network to indicate the threshold quantity of attempts (N) may be included in a configuration for the two-step random access procedure (e.g., a RACH-ConfigGenericTwoStepRA IE)

As part of the four-step random access procedure 516, the UE may transmit one or more random access messages. In some examples, the UE may determine a waveform type for transmitting a third random access message (e.g., Msg3) based on whether the value of a received power 520 exceeds or fails to exceed a second waveform threshold 507 (e.g., indicated to the UE via a msg3-waveform-RSRP-Threshold IE). For example, if the value of the received power 520 fails to exceed the second waveform threshold 507 (e.g., if the value of the received power 520 occurs in a region 511-a) the UE may determine to transmit the third random access message with transform precoding enabled (e.g., using the DFT-S-OFDM waveform). Additionally, or alternatively, if the value of the received power 520 exceeds the second waveform threshold 507 (e.g., if the value of the received power 520 occurs in a region 511-b) the UE may determine to transmit the third random access message with transform precoding enabled (e.g., using the DFT-S-OFDM waveform) or with transform precoding disabled (e.g., using the CP-OFDM waveform) based on a cell-specific parameter (e.g., the msg3-TransformPrecoder IE of the RACH-ConfigCommon IE). That is, if the value of the received power 520 occurs in the region 511-b, the UE may transmit the third random access message using a cell-specific waveform type indicated via the cell-specific parameter configured for the four-step random access procedure 516. In some examples, by configuring the UE with multiple thresholds for selecting a waveform at initial access based on the radio conditions of the UE, the network may provide one or more enhancements to random access procedures performed by the UE, among other benefits.

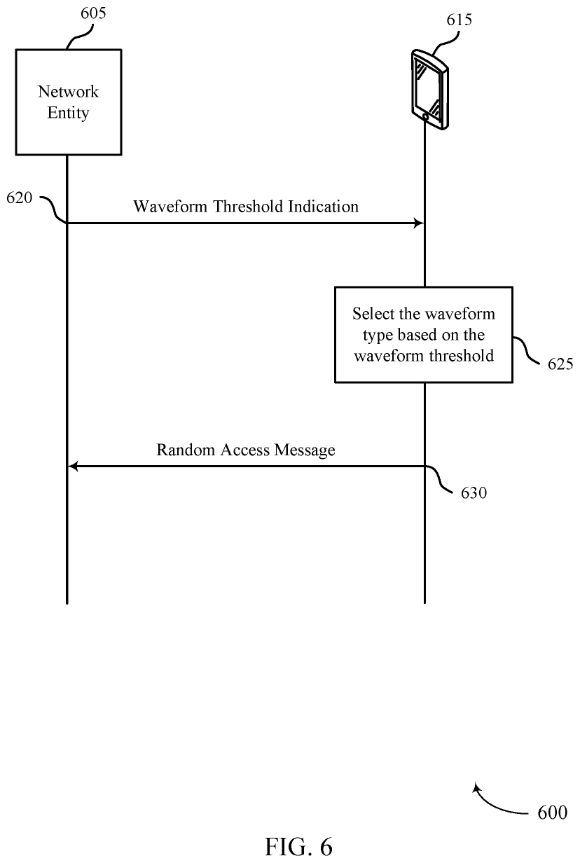

FIG. 6 illustrates an example of a process flow 600 that supports waveform selection in initial access in accordance with one or more aspects of the present disclosure. The process flow 600 may implement or be implemented by one or more aspects of the wireless communications system 100 and the wireless communications system 200. For example, the process flow 600 may include a network entity 605 and a UE 615, which may be examples of the corresponding devices as described with reference to FIGS. 1 and 2. The process flow 600 may be implemented by the network entity 605, the UE 615, or both. In the following description of the process flow 600, operations between the network entity 605 and the UE 615 may occur in a different order or at different times than as shown. Some operations may also be omitted from the process flow 600, and other operations may be added to the process flow 600. The process flow 600 may include features for improved communications between the UE and the network, among other benefits.

As illustrated in the example of FIG. 6, the network may configure the UE 615 to select a waveform type used for wireless communications with the network during initial access based on UE radio conditions. For example, at 620, the UE 615 may receive a waveform threshold indication from the network entity 605. In some examples, the waveform threshold indication (e.g., transmitted at 605) may be an example of a waveform threshold indication as described with reference to FIGS. 2 through 5. For example, the waveform threshold indication may indicate a waveform threshold for selecting a waveform type for transmitting a message of a random access procedure.

At 625, the UE 615 may select the waveform type for the random access message based on the waveform threshold (e.g., indicated by the waveform threshold indication received at 620) and a value associated with a power of signals received at the UE 615 (e.g., from the network entity 605). In some examples, the value associated with a power of signals received at the UE 615 may correspond to SS-RSRP measurements, an effective RSRP calculated based on the SS-RSRP measurements, or one or more other receive power measurements. In some examples, the waveform threshold may be an example of a waveform threshold as described with reference to FIGS. 2 through 5. For example, the waveform threshold may correspond to a first waveform threshold for a two-step random access procedure or a second waveform threshold for a four-step random access procedure.

At 630, the UE 615 may transmit a random access message according to the waveform type selected for the random access message at 625. The random access message may be an example of a random access message as described with reference FIGS. 2 through 5. For example, the random access message may be an example of a first random access message transmitted as part of a two-step random access procedure or a third random access message transmitted as part of a four-step random access procedure. In some examples, by enabling the UE 615 to select a waveform at initial access based on the radio conditions of the UE 615, the network may provide one or more enhancements to random access procedures performed by the UE 615, among other benefits.

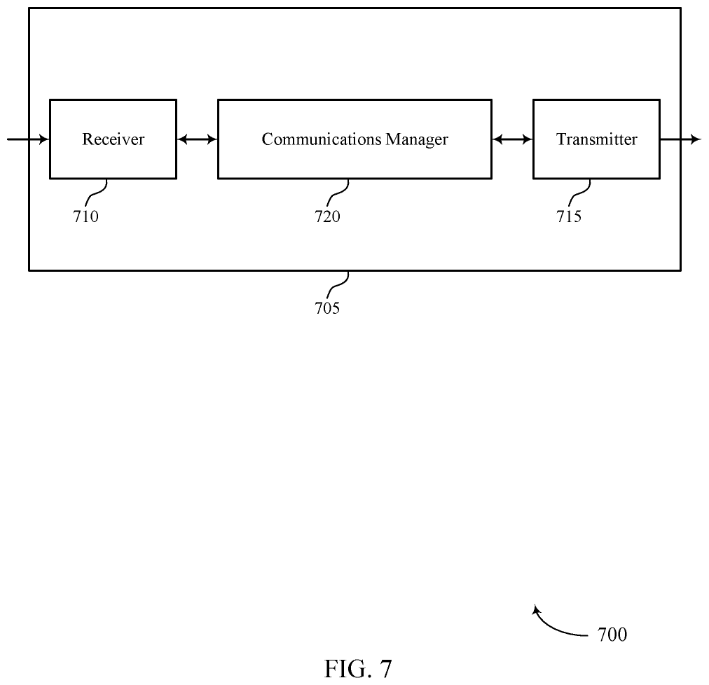

FIG. 7 shows a block diagram 700 of a device 705 that supports waveform selection in initial access in accordance with one or more aspects of the present disclosure. The device 705 may be an example of aspects of a UE 115 as described herein. The device 705 may include a receiver 710, a transmitter 715, and a communications manager 720. The device 705 may also include one or more processors, memory coupled with the one or more processors, and instructions stored in the memory that are executable by the one or more processors to enable the one or more processors to perform the waveform selection features discussed herein. Each of these components may be in communication with one another (e.g., via one or more buses).

The receiver 710 may provide a means for receiving information such as packets, user data, control information, or any combination thereof associated with various information channels (e.g., control channels, data channels, information channels related to waveform selection in initial access). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to waveform selection in initial access). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of waveform selection in initial access as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE (e.g., the device 705) in accordance with examples as disclosed herein. For example, the communications manager 720 may be configured as or otherwise support a means for receiving an indication of a waveform threshold for selecting a waveform type for transmitting a message of a random access procedure. The communications manager 720 may be configured as or otherwise support a means for selecting the waveform type for the message of the random access procedure based on the waveform threshold and a value associated with a power of signals received at the UE. The communications manager 720 may be configured as or otherwise support a means for transmitting the message of the random access procedure according to the waveform type selected for the message.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for reduced processing and more efficient utilization of communication resources.

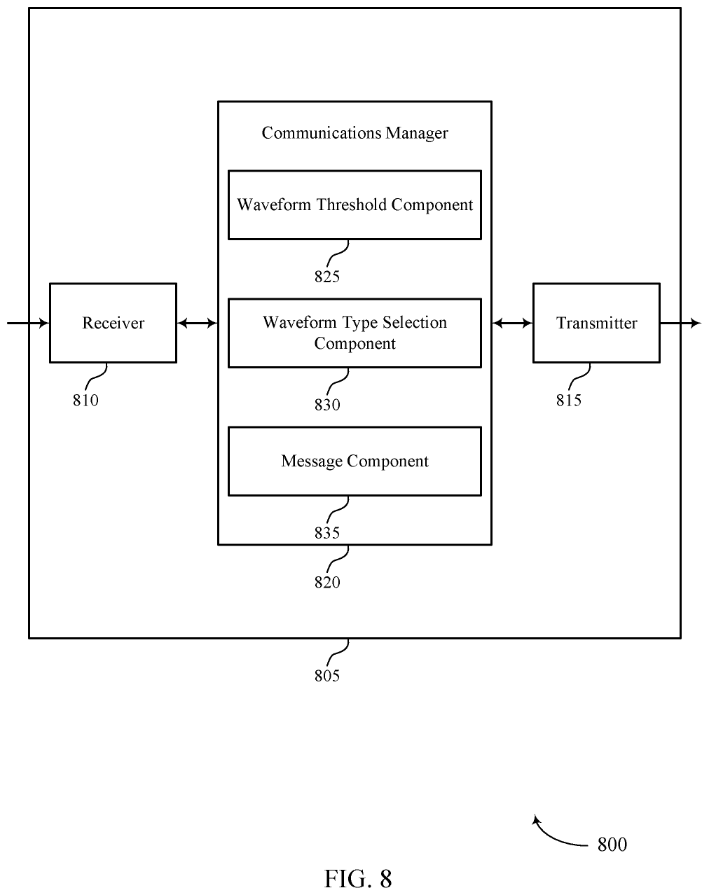

FIG. 8 shows a block diagram 800 of a device 805 that supports waveform selection in initial access in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to waveform selection in initial access). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to waveform selection in initial access). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of waveform selection in initial access as described herein. For example, the communications manager 820 may include a waveform threshold component 825, a waveform type selection component 830, a message component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a UE (e.g., the device 805) in accordance with examples as disclosed herein. The waveform threshold component 825 may be configured as or otherwise support a means for receiving an indication of a waveform threshold for selecting a waveform type for transmitting a message of a random access procedure. The waveform type selection component 830 may be configured as or otherwise support a means for selecting the waveform type for the message of the random access procedure based on the waveform threshold and a value associated with a power of signals received at the UE. The message component 835 may be configured as or otherwise support a means for transmitting the message of the random access procedure according to the waveform type selected for the message.

In some cases, the waveform threshold component 825, the waveform type selection component 830, and the message component 835 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the waveform threshold component 825, the waveform type selection component 830, and the message component 835 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

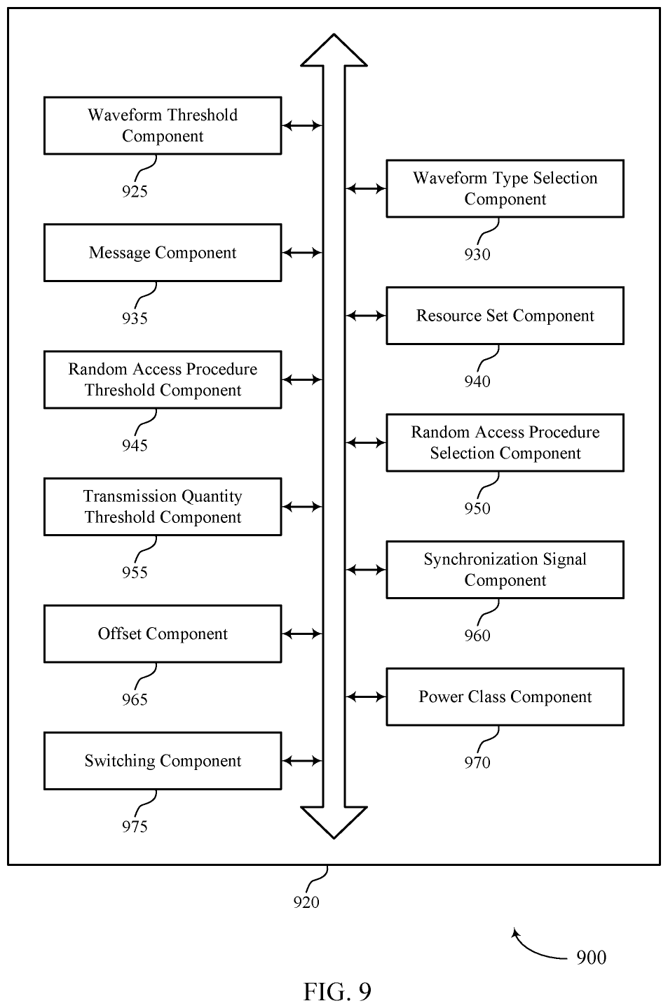

FIG. 9 shows a block diagram 900 of a communications manager 920 that supports waveform selection in initial access in accordance with one or more aspects of the present disclosure. The communications manager 920 may be an example of aspects of a communications manager 720, a communications manager 820, or both, as described herein. The communications manager 920, or various components thereof, may be an example of means for performing various aspects of waveform selection in initial access as described herein. For example, the communications manager 920 may include a waveform threshold component 925, a waveform type selection component 930, a message component 935, a resource set component 940, a random access procedure threshold component 945, a random access procedure selection component 950, a transmission quantity threshold component 955, a synchronization signal component 960, an offset component 965, a power class component 970, a switching component 975, or any combination thereof. Each of these components may communicate, directly or indirectly, with one another (e.g., via one or more buses).

The communications manager 920 may support wireless communication at a UE in accordance with examples as disclosed herein. The waveform threshold component 925 may be configured as or otherwise support a means for receiving an indication of a waveform threshold for selecting a waveform type for transmitting a message of a random access procedure. The waveform type selection component 930 may be configured as or otherwise support a means for selecting the waveform type for the message of the random access procedure based on the waveform threshold and a value associated with a power of signals received at the UE. The message component 935 may be configured as or otherwise support a means for transmitting the message of the random access procedure according to the waveform type selected for the message.

In some examples, the random access procedure includes a first type of random access procedure, and the waveform threshold component 925 may be configured as or otherwise support a means for receiving an indication of a second waveform threshold for selecting a waveform type for UE transmissions of a second type of random access procedure.

In some examples, the waveform type selected for the message includes a first waveform type, and the resource set component 940 may be configured as or otherwise support a means for receiving an indication of a first set of resources for transmitting the message of the random access procedure according to the first waveform type and a second set of resources for transmitting the message of the random access procedure according to a second waveform type, where the message of the random access procedure is transmitted using the first set of resources based on the first waveform type being selected for the message.

In some examples, the first set of resources include a first set of time-frequency resources and the second set of resources include a second set of time-frequency resources. In some examples, the first set of resources include a first one or more preamble sequences and the second set of resources include second one or more preamble sequences. In some examples, any combination thereof.

In some examples, the random access procedure threshold component 945 may be configured as or otherwise support a means for receiving an indication of a random access procedure threshold for selecting from a set of multiple random access procedures. In some examples, the random access procedure selection component 950 may be configured as or otherwise support a means for selecting the random access procedure from the set of multiple random access procedures based on the random access procedure threshold and the value associated with the power for the signals received at the UE.

In some examples, the set of multiple random access procedures include at least a two-step random access procedure corresponding to the value associated with the power for the signals received at the UE satisfying the random access procedure threshold and a four-step random access procedure corresponding to the value associated with the power for the signals received at the UE failing to satisfy the random access procedure threshold. In some examples, to support receiving the indication of the waveform threshold, the waveform threshold component 925 may be configured as or otherwise support a means for receiving a SIB including the indication of the waveform threshold.

In some examples, the waveform type includes a first waveform type, and the transmission quantity threshold component 955 may be configured as or otherwise support a means for receiving an indication of a transmission quantity threshold for transmitting the message according to the first waveform type, where the transmission quantity threshold is less than a maximum quantity of transmissions of the message during the random access procedure, and where the transmission quantity threshold corresponds to a quantity of random access attempts.

In some examples, the message component 935 may be configured as or otherwise support a means for transmitting a set of multiple messages according to the first waveform type, including the message. In some examples, the switching component 975 may be configured as or otherwise support a means for switching from transmitting the message according to the first waveform type to transmitting the message according to a second waveform type based on a quantity of the set of multiple messages exceeding the transmission quantity threshold.

In some examples, to support receiving the indication of the transmission quantity threshold, the transmission quantity threshold component 955 may be configured as or otherwise support a means for receiving a SIB including the indication of the transmission quantity threshold. In some examples, the synchronization signal component 960 may be configured as or otherwise support a means for receiving one or more synchronization signals, where the signals received at the UE include the one or more synchronization signals, and the value associated with the power for the signals received at the UE is based on the one or more synchronization signals.

In some examples, the power for the signals received at the UE includes a first power, and the offset component 965 may be configured as or otherwise support a means for determining an offset between the first power and a second power for signals transmitted by the UE, where the waveform type of the message is selected based on the offset. In some examples, the offset is associated with a difference between a first carrier frequency of the signals received at the UE and a second carrier frequency of the signals transmitted by the UE.

In some examples, the power class component 970 may be configured as or otherwise support a means for determining the value associated with the power for the signals received at the UE based on a power class for the UE. In some examples, the value associated with the power of the signals received at the UE include an RSRP.

In some examples, to support selecting the waveform type, the waveform type selection component 930 may be configured as or otherwise support a means for selecting a first waveform type based on the value associated with the power for the signals received at the UE satisfying the waveform threshold. In some examples, to support selecting the waveform type, the waveform type selection component 930 may be configured as or otherwise support a means for selecting a second waveform type based on the value associated with the power for the signals received at the UE failing to satisfy the waveform threshold, where the waveform type includes the first waveform type or the second waveform type.

In some examples, the second waveform type is a waveform type that is configured for a cell serving the UE. In some examples, the waveform type includes a discrete Fourier transform spread orthogonal frequency division multiplexing waveform or a cyclic prefix orthogonal frequency division multiplexing waveform.

In some cases, the waveform threshold component 925, the waveform type selection component 930, the message component 935, the resource set component 940, the random access procedure threshold component 945, the random access procedure selection component 950, the transmission quantity threshold component 955, the synchronization signal component 960, the offset component 965, the power class component 970, and the switching component 975 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the waveform threshold component 925, the waveform type selection component 930, the message component 935, the resource set component 940, the random access procedure threshold component 945, the random access procedure selection component 950, the transmission quantity threshold component 955, the synchronization signal component 960, the offset component 965, the power class component 970, and the switching component 975 discussed herein.

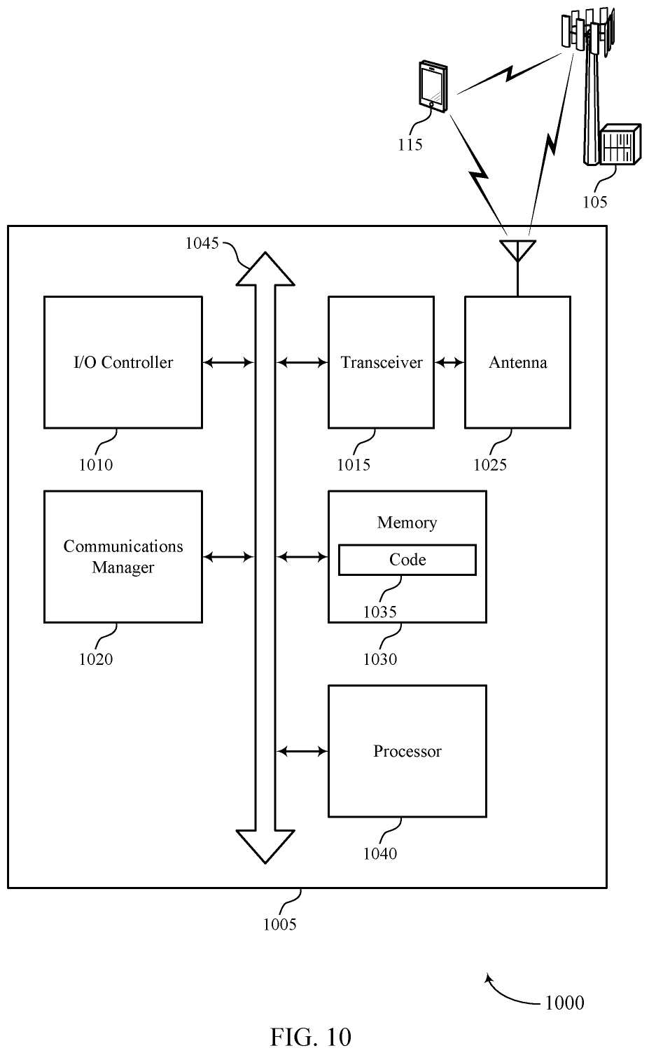

FIG. 10 shows a diagram of a system 1000 including a device 1005 that supports waveform selection in initial access in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting waveform selection in initial access). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a UE (e.g., the device 1005) in accordance with examples as disclosed herein. For example, the communications manager 1020 may be configured as or otherwise support a means for receiving an indication of a waveform threshold for selecting a waveform type for transmitting a message of a random access procedure. The communications manager 1020 may be configured as or otherwise support a means for selecting the waveform type for the message of the random access procedure based on the waveform threshold and a value associated with a power of signals received at the UE. The communications manager 1020 may be configured as or otherwise support a means for transmitting the message of the random access procedure according to the waveform type selected for the message.

By including or configuring the communications manager 1020 in accordance with examples as described herein, the device 1005 may support techniques for improved communication reliability, improved user experience related to reduced processing, more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of waveform selection in initial access as described herein, or the processor 1040 and the memory 1030 may be otherwise configured to perform or support such operations.

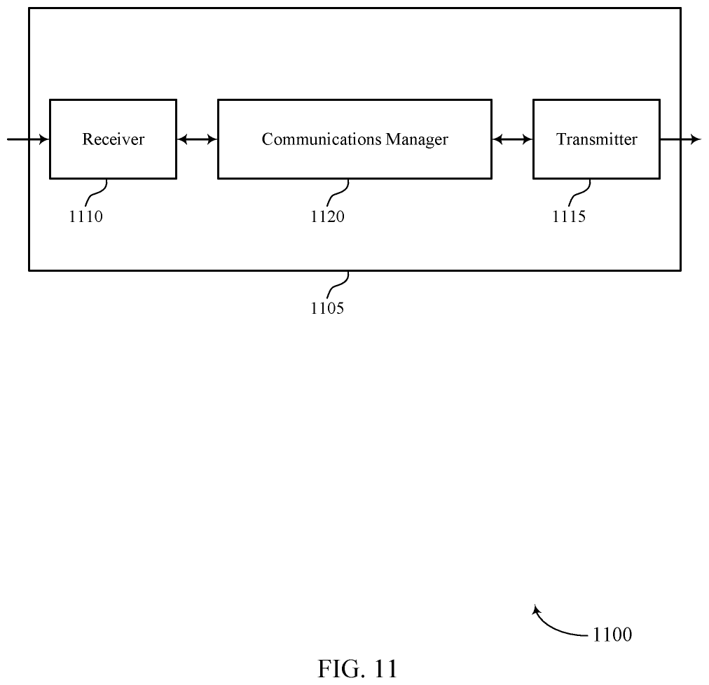

FIG. 11 shows a block diagram 1100 of a device 1105 that supports waveform selection in initial access in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include one or more processors, memory coupled with the one or more processors, and instructions stored in the memory that are executable by the one or more processors to enable the one or more processors to perform the waveform selection features discussed herein. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of waveform selection in initial access as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity (e.g., the device 1105) in accordance with examples as disclosed herein. For example, the communications manager 1120 may be configured as or otherwise support a means for outputting an indication of a waveform threshold for selecting a waveform type for a UE transmitting a message of a random access procedure. The communications manager 1120 may be configured as or otherwise support a means for obtaining the message of the random access procedure, where the waveform type of the message is based on the waveform threshold.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques for reduced processing and more efficient utilization of communication resources.

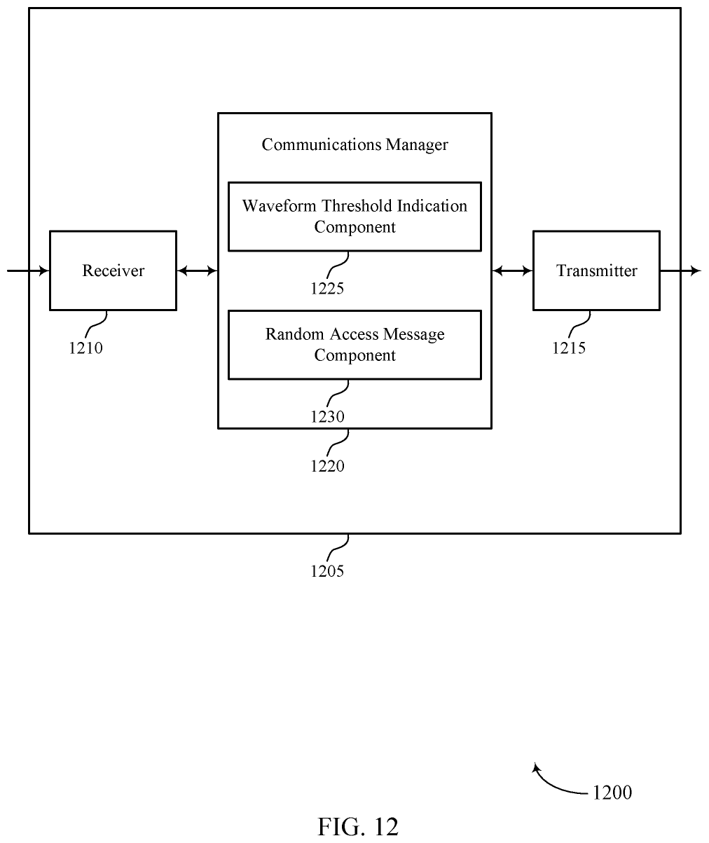

FIG. 12 shows a block diagram 1200 of a device 1205 that supports waveform selection in initial access in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of waveform selection in initial access as described herein. For example, the communications manager 1220 may include a waveform threshold indication component 1225 a random access message component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication at a network entity (e.g., the device 1205) in accordance with examples as disclosed herein. The waveform threshold indication component 1225 may be configured as or otherwise support a means for outputting an indication of a waveform threshold for selecting a waveform type for a UE transmitting a message of a random access procedure. The random access message component 1230 may be configured as or otherwise support a means for obtaining the message of the random access procedure, where the waveform type of the message is based on the waveform threshold.

In some cases, the waveform threshold indication component 1225 and the random access message component 1230 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the waveform threshold indication component 1225 and the random access message component 1230 discussed herein. A transceiver processor may be collocated with and/or communicate with (e.g., direct the operations of) a transceiver of the device. A radio processor may be collocated with and/or communicate with (e.g., direct the operations of) a radio (e.g., an NR radio, an LTE radio, a Wi-Fi radio) of the device. A transmitter processor may be collocated with and/or communicate with (e.g., direct the operations of) a transmitter of the device. A receiver processor may be collocated with and/or communicate with (e.g., direct the operations of) a receiver of the device.

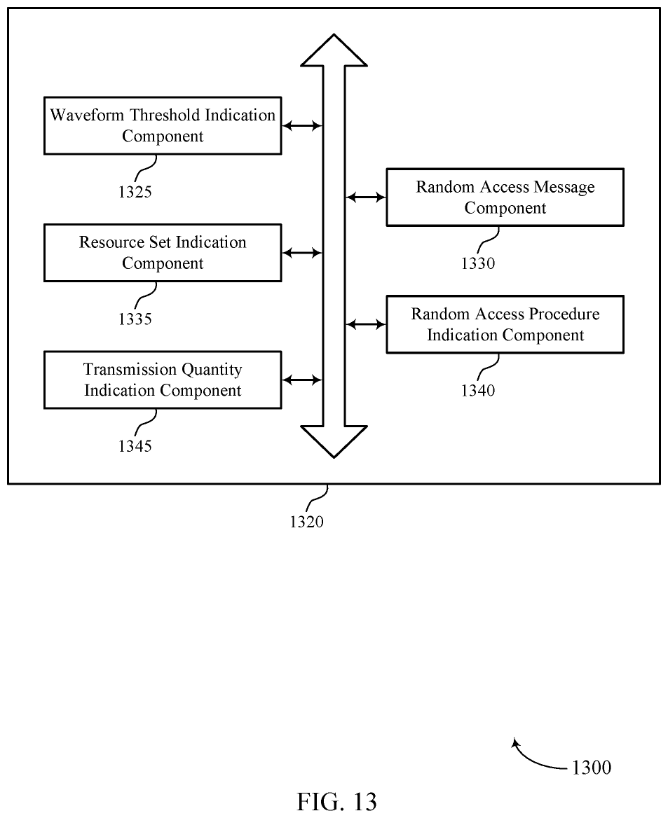

FIG. 13 shows a block diagram 1300 of a communications manager 1320 that supports waveform selection in initial access in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of waveform selection in initial access as described herein. For example, the communications manager 1320 may include a waveform threshold indication component 1325, a random access message component 1330, a resource set indication component 1335, a random access procedure indication component 1340, a transmission quantity indication component 1345, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication at a network entity in accordance with examples as disclosed herein. The waveform threshold indication component 1325 may be configured as or otherwise support a means for outputting an indication of a waveform threshold for selecting a waveform type for a UE transmitting a message of a random access procedure. The random access message component 1330 may be configured as or otherwise support a means for obtaining the message of the random access procedure, where the waveform type of the message is based on the waveform threshold.

In some examples, the random access procedure includes a first type of random access procedure, and the waveform threshold indication component 1325 may be configured as or otherwise support a means for outputting an indication of a second waveform threshold for selecting a waveform type for UE transmissions of a second type of random access procedure.

In some examples, to support obtaining the message of the random access procedure, the random access message component 1330 may be configured as or otherwise support a means for attempting to decode the message of the random access procedure according to a set of multiple waveform types to determine the waveform type of the message.

In some examples, the waveform type includes a first waveform type and, to support obtaining the message of the random access procedure, the resource set indication component 1335 may be configured as or otherwise support a means for outputting an indication of a first set of resources for transmitting the message of the random access procedure according to the first waveform type and a second set of resources for transmitting the message of the random access procedure according to a second waveform type.

In some examples, the random access procedure indication component 1340 may be configured as or otherwise support a means for outputting an indication of a random access procedure threshold for selecting from a set of multiple random access procedures. In some examples, the set of multiple random access procedures include at least a two-step random access procedure corresponding to a value associated with a power for signals received at the UE satisfying the random access procedure threshold and a four-step random access procedure corresponding to the value associated with the power for the signals received at the UE failing to satisfy the random access procedure threshold.

In some examples, the waveform type includes a first waveform type, and the transmission quantity indication component 1345 may be configured as or otherwise support a means for outputting an indication of a transmission quantity threshold for transmitting the message according to the first waveform type, where the transmission quantity threshold is less than a maximum quantity of transmissions of the message during the random access procedure. In some examples, the waveform threshold indication component 1325 may be configured as or otherwise support a means for outputting a SIB including the indication of the waveform threshold.

In some cases, the waveform threshold indication component 1325, the random access message component 1330, the resource set indication component 1335, the random access procedure indication component 1340, and the transmission quantity indication component 1345 may each be or be at least a part of a processor (e.g., a transceiver processor, or a radio processor, or a transmitter processor, or a receiver processor). The processor may be coupled with memory and execute instructions stored in the memory that enable the processor to perform or facilitate the features of the waveform threshold indication component 1325, the random access message component 1330, the resource set indication component 1335, the random access procedure indication component 1340, and the transmission quantity indication component 1345 discussed herein.

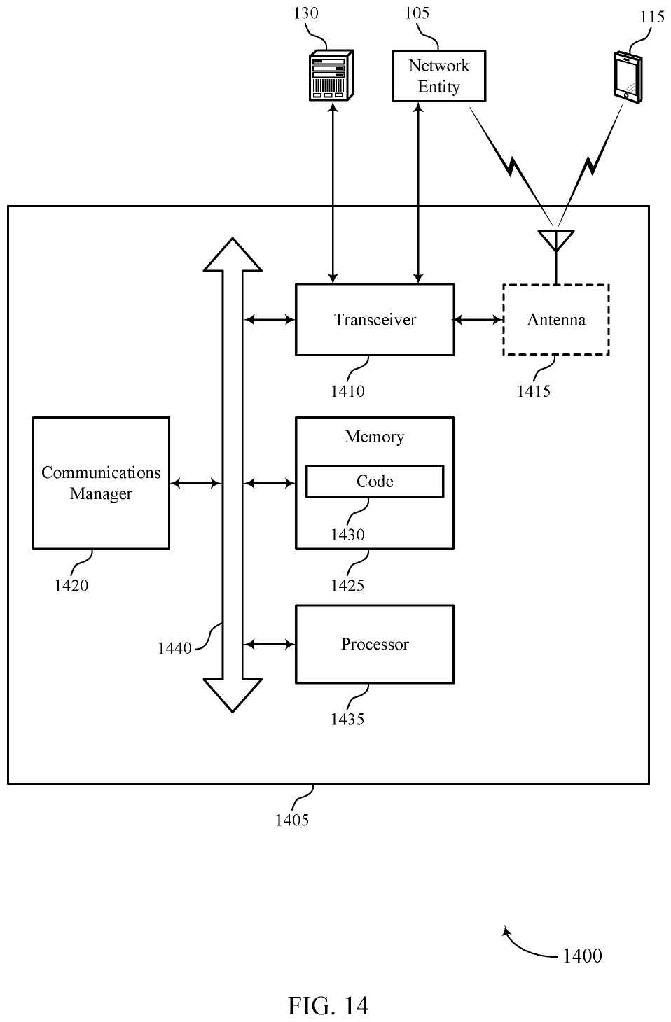

FIG. 14 shows a diagram of a system 1400 including a device 1405 that supports waveform selection in initial access in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting waveform selection in initial access). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communication at a network entity (e.g., the device 1405) in accordance with examples as disclosed herein. For example, the communications manager 1420 may be configured as or otherwise support a means for outputting an indication of a waveform threshold for selecting a waveform type for a UE transmitting a message of a random access procedure. The communications manager 1420 may be configured as or otherwise support a means for obtaining the message of the random access procedure, where the waveform type of the message is based on the waveform threshold.

By including or configuring the communications manager 1420 in accordance with examples as described herein, the device 1405 may support techniques for improved communication reliability, improved user experience related to reduced processing, more efficient utilization of communication resources, improved coordination between devices, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of waveform selection in initial access as described herein, or the processor 1435 and the memory 1425 may be otherwise configured to perform or support such operations.

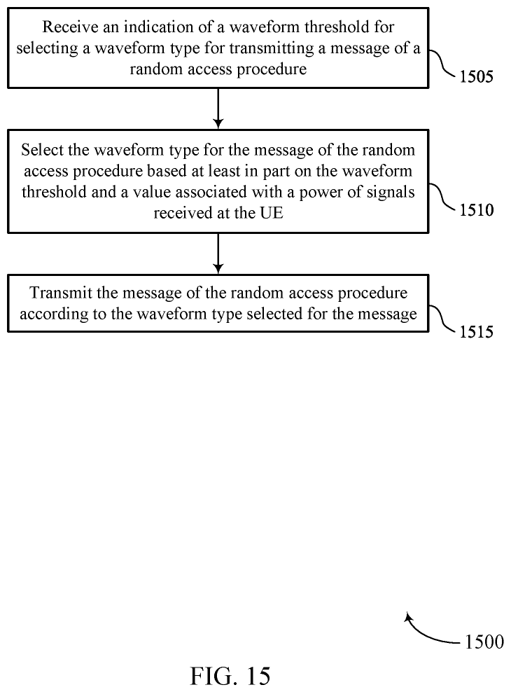

FIG. 15 shows a flowchart illustrating a method 1500 that supports waveform selection in initial access in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving an indication of a waveform threshold for selecting a waveform type for transmitting a message of a random access procedure. The operations of 1505 may be performed in accordance with examples as disclosed herein. In some examples, aspects of the operations of 1505 may be performed by a waveform threshold component 925 as described with reference to FIG. 9.

At 1510, the method may include selecting the waveform type for the message of the random access procedure based on the waveform threshold and a value associated with a power of signals received at the UE. The operations of 1510 may be performed in accordance with examples as disclosed herein. In some examples, aspects of the operations of 1510 may be performed by a waveform type selection component 930 as described with reference to FIG. 9.

At 1515, the method may include transmitting the message of the random access procedure according to the waveform type selected for the message. The operations of 1515 may be performed in accordance with examples as disclosed herein. In some examples, aspects of the operations of 1515 may be performed by a message component 935 as described with reference to FIG. 9.

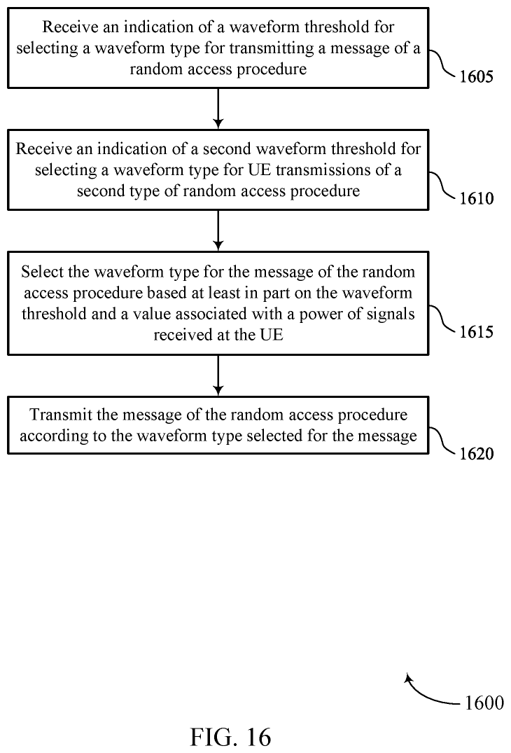

FIG. 16 shows a flowchart illustrating a method 1600 that supports waveform selection in initial access in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving an indication of a waveform threshold for selecting a waveform type for transmitting a message of a random access procedure. The operations of 1605 may be performed in accordance with examples as disclosed herein. In some examples, aspects of the operations of 1605 may be performed by a waveform threshold component 925 as described with reference to FIG. 9.

At 1610, the method may include receiving an indication of a second waveform threshold for selecting a waveform type for UE transmissions of a second type of random access procedure. The operations of 1610 may be performed in accordance with examples as disclosed herein. In some examples, aspects of the operations of 1610 may be performed by a waveform threshold component 925 as described with reference to FIG. 9.

At 1615, the method may include selecting the waveform type for the message of the random access procedure based on the waveform threshold and a value associated with a power of signals received at the UE. The operations of 1615 may be performed in accordance with examples as disclosed herein. In some examples, aspects of the operations of 1615 may be performed by a waveform type selection component 930 as described with reference to FIG. 9.

At 1620, the method may include transmitting the message of the random access procedure according to the waveform type selected for the message. The operations of 1620 may be performed in accordance with examples as disclosed herein. In some examples, aspects of the operations of 1620 may be performed by a message component 935 as described with reference to FIG. 9.

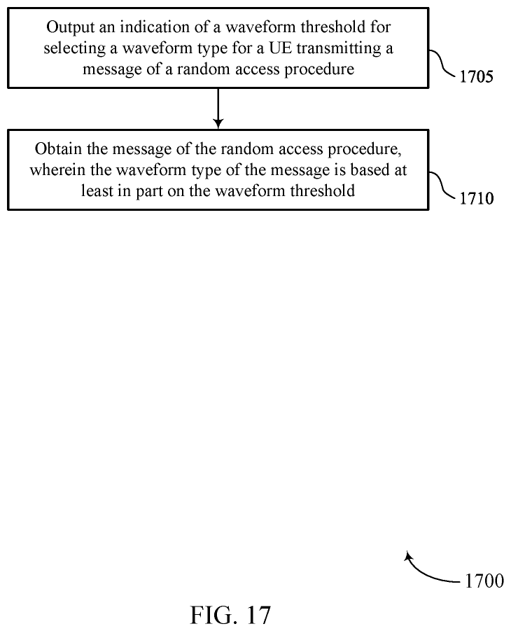

FIG. 17 shows a flowchart illustrating a method 1700 that supports waveform selection in initial access in accordance with one or more aspects of the present disclosure. The operations of the method 1700 may be implemented by a network entity or its components as described herein. For example, the operations of the method 1700 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1705, the method may include outputting an indication of a waveform threshold for selecting a waveform type for a UE transmitting a message of a random access procedure. The operations of 1705 may be performed in accordance with examples as disclosed herein. In some examples, aspects of the operations of 1705 may be performed by a waveform threshold indication component 1325 as described with reference to FIG. 13.

At 1710, the method may include obtaining the message of the random access procedure, where the waveform type of the message is based on the waveform threshold. The operations of 1710 may be performed in accordance with examples as disclosed herein. In some examples, aspects of the operations of 1710 may be performed by a random access message component 1330 as described with reference to FIG. 13.

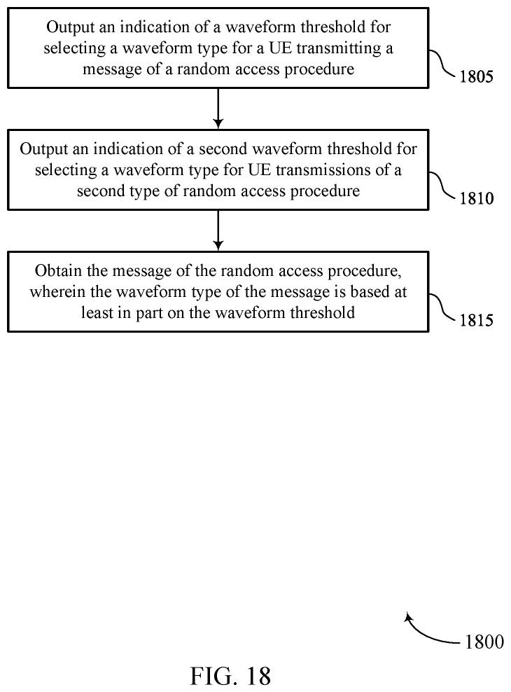

FIG. 18 shows a flowchart illustrating a method 1800 that supports waveform selection in initial access in accordance with one or more aspects of the present disclosure. The operations of the method 1800 may be implemented by a network entity or its components as described herein. For example, the operations of the method 1800 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include outputting an indication of a waveform threshold for selecting a waveform type for a UE transmitting a message of a random access procedure. The operations of 1805 may be performed in accordance with examples as disclosed herein. In some examples, aspects of the operations of 1805 may be performed by a waveform threshold indication component 1325 as described with reference to FIG. 13.

At 1810, the method may include outputting an indication of a second waveform threshold for selecting a waveform type for UE transmissions of a second type of random access procedure. The operations of 1810 may be performed in accordance with examples as disclosed herein. In some examples, aspects of the operations of 1810 may be performed by a waveform threshold indication component 1325 as described with reference to FIG. 13.

At 1815, the method may include obtaining the message of the random access procedure, where the waveform type of the message is based on the waveform threshold. The operations of 1815 may be performed in accordance with examples as disclosed herein. In some examples, aspects of the operations of 1815 may be performed by a random access message component 1330 as described with reference to FIG. 13.

The following provides an overview of aspects of the present disclosure:

Aspect 1: A method for wireless communication at a UE, comprising: receiving an indication of a waveform threshold for selecting a waveform type for transmitting a message of a random access procedure; selecting the waveform type for the message of the random access procedure based at least in part on the waveform threshold and a value associated with a power of signals received at the UE; and transmitting the message of the random access procedure according to the waveform type selected for the message.

Aspect 2: The method of aspect 1, wherein the random access procedure comprises a first type of random access procedure, the waveform threshold comprises a first waveform threshold, and the method further comprises: receiving an indication of a second waveform threshold for selecting a waveform type for UE transmissions of a second type of random access procedure.

Aspect 3: The method of any of aspects 1 through 2, wherein the waveform type selected for the message comprises a first waveform type, the method further comprising: receiving an indication of a first set of resources for transmitting the message of the random access procedure according to the first waveform type and a second set of resources for transmitting the message of the random access procedure according to a second waveform type, wherein the message of the random access procedure is transmitted using the first set of resources based at least in part on the first waveform type being selected for the message.

Aspect 4: The method of aspect 3, wherein the first set of resources comprise a first set of time-frequency resources and the second set of resources comprise a second set of time-frequency resources; the first set of resources comprise a first one or more preamble sequences and the second set of resources comprise second one or more preamble sequences; or any combination thereof.

Aspect 5: The method of any of aspects 1 through 4, further comprising: receiving an indication of a random access procedure threshold for selecting from a plurality of random access procedures; and selecting the random access procedure from the plurality of random access procedures based at least in part on the random access procedure threshold and the value associated with the power for the signals received at the UE.

Aspect 6: The method of aspect 5, wherein the plurality of random access procedures comprise at least a two-step random access procedure corresponding to the value associated with the power for the signals received at the UE satisfying the random access procedure threshold and a four-step random access procedure corresponding to the value associated with the power for the signals received at the UE failing to satisfy the random access procedure threshold.

Aspect 7: The method of any of aspects 1 through 6, wherein receiving the indication of the waveform threshold comprises: receiving a SIB comprising the indication of the waveform threshold.

Aspect 8: The method of any of aspects 1 through 7, wherein the waveform type comprises a first waveform type, the method further comprising: receiving an indication of a transmission quantity threshold for transmitting the message according to the first waveform type, wherein the transmission quantity threshold is less than a maximum quantity of transmissions of the message during the random access procedure, and wherein the transmission quantity threshold corresponds to a quantity of random access attempts.

Aspect 9: The method of aspect 8, further comprising: transmitting a plurality of messages according to the first waveform type, including the message; and switching from transmitting the message according to the first waveform type to transmitting the message according to a second waveform type based at least in part on a quantity of the plurality of messages exceeding the transmission quantity threshold.

Aspect 10: The method of any of aspects 8 through 9, wherein receiving the indication of the transmission quantity threshold comprises: receiving a SIB comprising the indication of the transmission quantity threshold.

Aspect 11: The method of any of aspects 1 through 10, further comprising: receiving one or more synchronization signals, wherein the signals received at the UE comprise the one or more synchronization signals, and the value associated with the power for the signals received at the UE is based at least in part on the one or more synchronization signals.

Aspect 12: The method of any of aspects 1 through 11, wherein the power for the signals received at the UE comprises a first power, the method further comprising: determining an offset between the first power and a second power for signals transmitted by the UE, wherein the waveform type of the message is selected based at least in part on the offset.

Aspect 13: The method of aspect 12, wherein the offset is associated with a difference between a first carrier frequency of the signals received at the UE and a second carrier frequency of the signals transmitted by the UE.

Aspect 14: The method of any of aspects 1 through 13, further comprising: determining the value associated with the power for the signals received at the UE based at least in part on a power class for the UE.

Aspect 15: The method of any of aspects 1 through 14, wherein the value associated with the power of the signals received at the UE comprise an RSRP.

Aspect 16: The method of any of aspects 1 through 15, wherein selecting the waveform type comprises: selecting a first waveform type based at least in part on the value associated with the power for the signals received at the UE satisfying the waveform threshold; and selecting a second waveform type based at least in part on the value associated with the power for the signals received at the UE failing to satisfy the waveform threshold, wherein the waveform type comprises the first waveform type or the second waveform type.

Aspect 17: The method of aspect 16, wherein the second waveform type is a waveform type that is configured for a cell serving the UE.

Aspect 18: The method of any of aspects 1 through 17, wherein the waveform type comprises a DFT-S-OFDM waveform or a CP-OFDM waveform.

Aspect 19: A method for wireless communication at a network entity, comprising: outputting an indication of a waveform threshold for selecting a waveform type for a UE transmitting a message of a random access procedure; and obtaining the message of the random access procedure, wherein the waveform type of the message is based at least in part on the waveform threshold.

Aspect 20: The method of aspect 19, wherein the random access procedure comprises a first type of random access procedure, the waveform threshold comprises a first waveform threshold, and the method further comprises: outputting an indication of a second waveform threshold for selecting a waveform type for UE transmissions of a second type of random access procedure.

Aspect 21: The method of any of aspects 19 through 20, wherein obtaining the message of the random access procedure comprises: attempting to decode the message of the random access procedure according to a plurality of waveform types to determine the waveform type of the message.

Aspect 22: The method of any of aspects 19 through 21, wherein the waveform type comprises a first waveform type and obtaining the message of the random access procedure comprises: outputting an indication of a first set of resources for transmitting the message of the random access procedure according to the first waveform type and a second set of resources for transmitting the message of the random access procedure according to a second waveform type.

Aspect 23: The method of any of aspects 19 through 22, further comprising: outputting an indication of a random access procedure threshold for selecting from a plurality of random access procedures.

Aspect 24: The method of aspect 23, wherein the plurality of random access procedures comprise at least a two-step random access procedure corresponding to a value associated with a power for signals received at the UE satisfying the random access procedure threshold and a four-step random access procedure corresponding to the value associated with the power for the signals received at the UE failing to satisfy the random access procedure threshold.

Aspect 25: The method of any of aspects 19 through 24, wherein the waveform type comprises a first waveform type, the method further comprising: outputting an indication of a transmission quantity threshold for transmitting the message according to the first waveform type, wherein the transmission quantity threshold is less than a maximum quantity of transmissions of the message during the random access procedure.

Aspect 26: The method of any of aspects 19 through 25, further comprising: outputting a SIB comprising the indication of the waveform threshold.

Aspect 27: An apparatus for wireless communication at a UE, comprising a processor; memory coupled with the processor; and instructions stored in the memory and executable by the processor to cause the apparatus to perform a method of any of aspects 1 through 18.

Aspect 28: An apparatus for wireless communication at a UE, comprising at least one means for performing a method of any of aspects 1 through 18.

Aspect 29: A non-transitory computer-readable medium storing code for wireless communication at a UE, the code comprising instructions executable by a processor to perform a method of any of aspects 1 through 18.

Aspect 30: An apparatus for wireless communication at a network entity, comprising a processor; memory coupled with the processor; and instructions stored in the memory and executable by the processor to cause the apparatus to perform a method of any of aspects 19 through 26.

Aspect 31: An apparatus for wireless communication at a network entity, comprising at least one means for performing a method of any of aspects 19 through 26.

Aspect 32: A non-transitory computer-readable medium storing code for wireless communication at a network entity, the code comprising instructions executable by a processor to perform a method of any of aspects 19 through 26.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a user equipment (UE), comprising:
a processor;
memory coupled with the processor; and
instructions stored in the memory and executable by the processor to cause the apparatus to:
receive an indication of a waveform threshold for selecting a waveform type for transmitting a message of a random access procedure;
select the waveform type for the message of the random access procedure based at least in part on the waveform threshold and a value associated with a power of signals received at the UE; and
transmit the message of the random access procedure according to the waveform type selected for the message.

2. The apparatus of claim 1, wherein the random access procedure comprises a first type of random access procedure, and the instructions are further executable by the processor to cause the apparatus to:
receive an indication of a second waveform threshold for selecting a waveform type for UE transmissions of a second type of random access procedure.

3. The apparatus of claim 1, wherein the waveform type selected for the message comprises a first waveform type, and the instructions are further executable by the processor to cause the apparatus to:
receive an indication of a first set of resources for transmitting the message of the random access procedure according to the first waveform type and a second set of resources for transmitting the message of the random access procedure according to a second waveform type, wherein the message of the random access procedure is transmitted using the first set of resources based at least in part on the first waveform type being selected for the message.

4. The apparatus of claim 3, wherein:
the first set of resources comprise a first set of time-frequency resources and the second set of resources comprise a second set of time-frequency resources;
the first set of resources comprise a first one or more preamble sequences and the second set of resources comprise second one or more preamble sequences; or
any combination thereof.

5. The apparatus of claim 1, wherein the instructions are further executable by the processor to receive the indication of the waveform threshold by being executable by the processor to:
receive a system information block comprising the indication of the waveform threshold.

6. The apparatus of claim 1, wherein the waveform type comprises a first waveform type, and the instructions are further executable by the processor to cause the apparatus to:
receive an indication of a transmission quantity threshold for transmitting the message according to the first waveform type, wherein the transmission quantity threshold is less than a maximum quantity of transmissions of the message during the random access procedure, and wherein the transmission quantity threshold corresponds to a quantity of random access attempts.

7. The apparatus of claim 6, wherein the instructions are further executable by the processor to cause the apparatus to:
transmit a plurality of messages according to the first waveform type, including the message; and
switch from transmitting the message according to the first waveform type to transmitting the message according to a second waveform type based at least in part on a quantity of the plurality of messages exceeding the transmission quantity threshold.

8. The apparatus of claim 6, wherein the instructions are further executable by the processor to receive the indication of the transmission quantity threshold by being executable by the processor to:
receive a system information block comprising the indication of the transmission quantity threshold.

9. The apparatus of claim 1, wherein the instructions are further executable by the processor to cause the apparatus to:
receive one or more synchronization signals, wherein the signals received at the UE comprise the one or more synchronization signals, and the value associated with the power for the signals received at the UE is based at least in part on the one or more synchronization signals.

10. The apparatus of claim 1, wherein the power for the signals received at the UE comprises a first power, and the instructions are further executable by the processor to cause the apparatus to:
determine an offset between the first power and a second power for signals transmitted by the UE, wherein the waveform type of the message is selected based at least in part on the offset.

11. The apparatus of claim 10, wherein the offset is associated with a difference between a first carrier frequency of the signals received at the UE and a second carrier frequency of the signals transmitted by the UE.

12. The apparatus of claim 1, wherein the instructions are further executable by the processor to cause the apparatus to:
determine the value associated with the power for the signals received at the UE based at least in part on a power class for the UE.

13. The apparatus of claim 1, wherein the value associated with the power of the signals received at the UE comprise a reference signal received power.

14. The apparatus of claim 1, wherein the instructions are further executable by the processor to select the waveform type by being executable by the processor to:
select a first waveform type based at least in part on the value associated with the power for the signals received at the UE satisfying the waveform threshold; and
select a second waveform type based at least in part on the value associated with the power for the signals received at the UE failing to satisfy the waveform threshold, wherein the waveform type comprises the first waveform type or the second waveform type.

15. The apparatus of claim 14, wherein the second waveform type is a waveform type that is configured for a cell serving the UE.

16. The apparatus of claim 1, wherein the waveform type comprises a discrete Fourier transform spread orthogonal frequency division multiplexing waveform or a cyclic prefix orthogonal frequency division multiplexing waveform.

17. An apparatus for wireless communication at a network entity, comprising:
a processor;
memory coupled with the processor; and
instructions stored in the memory and executable by the processor to cause the apparatus to:
output an indication of a waveform threshold for selecting a waveform type for a user equipment (UE) transmitting a message of a random access procedure; and
obtain the message of the random access procedure, wherein the waveform type of the message is based at least in part on the waveform threshold.

18. The apparatus of claim 17, wherein the random access procedure comprises a first type of random access procedure, and the instructions are further executable by the processor to cause the apparatus to:
output an indication of a second waveform threshold for selecting a waveform type for UE transmissions of a second type of random access procedure.

19. The apparatus of claim 17, wherein the instructions are further executable by the processor to obtain the message of the random access procedure by being executable by the processor to:
attempt to decode the message of the random access procedure according to a plurality of waveform types to determine the waveform type of the message.

20. The apparatus of claim 17, wherein the waveform type comprises a first waveform type and the instructions are further executable by the processor to obtain the message of the random access procedure by being executable by the processor to:
output an indication of a first set of resources for transmitting the message of the random access procedure according to the first waveform type and a second set of resources for transmitting the message of the random access procedure according to a second waveform type.

21. The apparatus of claim 17, wherein the waveform type comprises a first waveform type, and the instructions are further executable by the processor to cause the apparatus to:
output an indication of a transmission quantity threshold for transmitting the message according to the first waveform type, wherein the transmission quantity threshold is less than a maximum quantity of transmissions of the message during the random access procedure.

22. The apparatus of claim 17, wherein the instructions are further executable by the processor to cause the apparatus to:
output a system information block comprising the indication of the waveform threshold.

23. A method for wireless communication at a user equipment (UE), comprising:
receiving an indication of a waveform threshold for selecting a waveform type for transmitting a message of a random access procedure;
selecting the waveform type for the message of the random access procedure based at least in part on the waveform threshold and a value associated with a power of signals received at the UE; and
transmitting the message of the random access procedure according to the waveform type selected for the message.

24. The method of claim 23, wherein the random access procedure comprises a first type of random access procedure, the waveform threshold comprises a first waveform threshold, and the method further comprises:
receiving an indication of a second waveform threshold for selecting a waveform type for UE transmissions of a second type of random access procedure.

25. The method of claim 23, wherein the waveform type selected for the message comprises a first waveform type, the method further comprising:
receiving an indication of a first set of resources for transmitting the message of the random access procedure according to the first waveform type and a second set of resources for transmitting the message of the random access procedure according to a second waveform type, wherein the message of the random access procedure is transmitted using the first set of resources based at least in part on the first waveform type being selected for the message.

26. The method of claim 25, wherein:
the first set of resources comprise a first set of time-frequency resources and the second set of resources comprise a second set of time-frequency resources;
the first set of resources comprise a first one or more preamble sequences and the second set of resources comprise second one or more preamble sequences; or
any combination thereof.

27. A method for wireless communication at a network entity, comprising:
outputting an indication of a waveform threshold for selecting a waveform type for a user equipment (UE) transmitting a message of a random access procedure; and
obtaining the message of the random access procedure, wherein the waveform type of the message is based at least in part on the waveform threshold.

28. The method of claim 27, wherein the random access procedure comprises a first type of random access procedure, the waveform threshold comprises a first waveform threshold, and the method further comprises:
outputting an indication of a second waveform threshold for selecting a waveform type for UE transmissions of a second type of random access procedure.

29. The method of claim 27, wherein obtaining the message of the random access procedure comprises:
attempting to decode the message of the random access procedure according to a plurality of waveform types to determine the waveform type of the message.

30. The method of claim 27, wherein the waveform type comprises a first waveform type and obtaining the message of the random access procedure comprises:
outputting an indication of a first set of resources for transmitting the message of the random access procedure according to the first waveform type and a second set of resources for transmitting the message of the random access procedure according to a second waveform type.
